(19) United States
(12) Patent Application Publication
(10) Pub. No.: US 2011/0171570 A1
(43) Pub. Date: Jul. 14, 2011

(54) ELECTROPHOTOGRAPHIC PHOTORECEPTOR, METHOD OF PRODUCING SAME, PROCESS CARTRIDGE, AND IMAGE FORMING APPARATUS

(75) Inventors: Hitoshi TAKIMOTO, Kanagawa (JP); Masahiro Iwasaki, Kanagawa (JP); Daisuke Haruyama, Kanagawa (JP); Hidemi Nukada, Kanagawa (JP); Mitsuhide Nakamura, Kanagawa (JP); Koji Bando, Kanagawa (JP)

(73) Assignee: FUJI XEROX CO., LTD., TOKYO (JP)

(21) Appl. No.: 12/860,406

(22) Filed: Aug. 20, 2010

(30) Foreign Application Priority Data
Jan. 8, 2010 (JP) 2010-003093

(51) Int. Cl. G03G 15/00; G03G 21/18

(52) U.S. Cl. 430/56; 399/111; 399/159

(57) ABSTRACT

The invention provides an electrophotographic photoreceptor having at least: a substrate; a photosensitive layer provided on the substrate; and an overcoat layer provided on the photosensitive layer. The overcoat layer of the photoreceptor includes at least: a cross-linked component that is obtained by cross-linking of at least one selected from a guanamine compound or a melamine compound and a charge-transporting material having at least one substituent group selected from —OH, —OCH₃, —NH₂, —SH, or —COOH; fluoro-resin particles; and a fluoro-alkyl group-containing copolymer. The ratio of fluorine atom present in an outermost surface of the overcoat layer as measured with energy dispersive X-ray analysis (EDS) is from approximately 1.0% by mass to approximately 20.0% by mass. The invention further provides a process cartridge, an image forming apparatus, and a method of producing the electrophotographic photoreceptor.

### CROSS-REFERENCE TO RELATED APPLICATIONS

This application claims priority under 35 USC 119 from Japanese Patent Application No. 2010-003093 filed on Jan. 8, 2010.

### BACKGROUND ART

1. Technical Field

The invention relates to an electrophotographic photoreceptor, a method of producing the electrophotographic photoreceptor, a process cartridge, and an image forming apparatus.

2. Related Art

Generally, an electrophotographic image forming apparatus has the following structure and processes. Specifically, the surface of an electrophotographic photoreceptor is uniformly charged by a charging means to desired polarity and potential, and the charged surface of the electrophotographic photoreceptor is selectively removed of charge by subjecting to image-wise exposure to form an electrostatic latent image. The latent image is then developed into a toner image by attaching a toner to the electrostatic latent image by a developing means, and the toner image is transferred to an image-receiving medium by a transfer means, then the image-receiving medium is discharged as an image formed material.

### SUMMARY

An exemplary embodiment of one aspect of the present invention is an electrophotographic photoreceptor comprising: a substrate; a photosensitive layer provided on the substrate; and an overcoat layer provided on the photosensitive layer, the overcoat layer of the photoreceptor comprising: a cross-linked component that is obtained by cross-linking of at least one selected from a guanamine compound or a melamine compound and a charge-transporting material having at least one substituent group selected from —OH, —OCH₃, —NH₂, —SH, or —COOH; fluoro-resin particles; and a fluoro-alkyl group-containing copolymer, and the ratio of fluorine atom present in an outermost surface of the overcoat layer as measured with energy dispersive X-ray analysis (EDS) being from approximately 1.0% by mass to approximately 20M % by mass.

Numerical values herein described and accompanied with “approximately” or “about” each include both the precise numerical value as well as the numerical range which is near to the numerical value. For example, “approximately 1.0% by mass” encompasses both the exact value of 1.0% by mass and numerical values which are approximately 1.0% by mass.

### BRIEF DESCRIPTION OF THE DRAWINGS

Exemplary embodiments of the present invention are described in detail on the following figures, wherein:

FIG. 1 is a schematic partial cross-sectional view showing the electrophotographic photoreceptor according to a first exemplary embodiment of the first aspect of the invention;

FIG. 2 is a schematic partial cross-sectional view showing the electrophotographic photoreceptor according a second exemplary embodiment of the first aspect of the invention;

FIG. 3 is a schematic partial cross-sectional view showing the electrophotographic photoreceptor according a third exemplary embodiment of the first aspect of the invention;

FIG. 4 is a schematic view showing an image forming apparatus according to an exemplary embodiment of another aspect of the invention; and

FIG. 5 is a schematic view showing an image forming apparatus according to another exemplary embodiment of another aspect of the invention.

### DETAILED DESCRIPTION

### Electrophotographic Photoreceptor

An exemplary embodiment of one aspect of the invention is an electrophotographic photoreceptor (hereinafter, simply referred to as “photoreceptor” in some cases) has at least a substrate, a photosensitive layer provided on the substrate, and an overcoat layer provided on the photosensitive layer. The overcoat layer of the photoreceptor contains at least: a cross-linked component that is obtained by cross-linking of at least one selected from a guanamine compound or a melamine compound and a charge-transporting material having at least one substituent group selected from —OH, —OCH₃, —SH, or —COOH; fluoro-resin particles; and a fluoro-alkyl group-containing copolymer. The ratio of fluorine atom present in the outermost surface of the overcoat layer as measured with energy dispersive X-ray analysis (EDS) is from approximately 1.0% by mass to approximately 20.0% by mass.

The photoreceptor according to the exemplary embodiment has the ratio of the fluorine atom present in the outermost surface of the overcoat layer that is within the range of from approximately 1.0% by mass to approximately 20.0% by mass. Namely, the fluoro-resin particles are exposed in the outermost surface of the photoreceptor according to the exemplary embodiment.

Upon forming the overcoat layer by applying a coating liquid for forming the overcoat layer and then by cross-linking, when a component that is among the components of the coating liquid and that is other than the fluoro-resin particles covers the surface of the fluoro-resin particles, the fluoro-resin particles may not be sufficiently exposed in the outermost surface.

In contrast to this, in the photoreceptor according to the exemplary embodiment, the fluoro-resin particles are exposed in a manner that the ratio of fluorine atom present is in the aforementioned range.

The ratio of fluorine atom present in the outermost surface of the overcoat layer may be preferably from approximately 1.5% by mass to approximately 12.0% by mass, and may be more preferably from approximately 1.5% by mass to approximately 8.0% by mass.

The measurement of the ratio of fluorine atom present in the outermost surface of the overcoat layer (that is, the measurement by energy dispersive X-ray analysis (EDS)) is carried out by using “TED-2300F” (trade name) manufactured by JEOL Ltd. at an acceleration voltage of 10 kV.

Method of Regulating Ratio of Fluorine Atom Present

The overcoat layer may be formed by applying a coating liquid that satisfies the following requirements (1) to (3) on the substrate, and then by performing cross-linking.

(1) The ratio of the sum of the content of the guanamine compound and the content of the melamine compound to the total solid content of the overcoat layer excluding the content of the fluoro-resin particles and the content of the fluoro-alkyl group-containing copolymer is from approximately 0.1% by mass to approximately 20% by mass;

(2) The ratio of the content of the charge-transporting material to the total solid content of the overcoat layer excluding the content of the fluoro-resin particles and the content of the fluoro-alkyl group-containing copolymer is from approximately 80% by mass to approximately 99.9% by mass; and

(3) The coating liquid contains at least a cyclic aliphatic ketone compound.

The ratio of the sum of the content of the guanamine compound and the content of the melamine compound to the total solid content of the overcoat layer excluding the content of the fluoro-resin particles and the content of the fluoro-alkyl group-containing copolymer may be more preferably from approximately 0.1% by mass to approximately 10.0% by mass, and further preferably from approximately 0.5% by mass to approximately 5.0% by mass.

On the other hand, the ratio of the content of the charge-transporting material to the total solid content of the overcoat layer excluding the content of the fluoro-resin particles and the content of the fluoro-alkyl group-containing copolymer may be more preferably from approximately 90% by mass to approximately 99.9% by mass, and further preferably from approximately 95.0% by mass to approximately 99.5% by mass.

The number of carbon atoms that compose the ring of the cyclic aliphatic ketone compound contained as a solvent in the coating liquid for forming the overcoat layer may be preferably from 4 to 7, and more preferably from 5 to 6. When the number of carbon atoms is 4 or more, the compound may become stable when it is heated. On the other hand, when the number of carbon atoms that compose the ring is 7 or less, the boiling point of the compound may not be too high and the compound may be easily vaporized by heating upon forming the overcoat layer.

From the viewpoint of attaining the ratio of fluorine atom present in the outermost surface of the overcoat layer, the fluoro-alkyl group-containing copolymer may be preferably a copolymer that has a repeating unit represented by the following Structural Formula (1) and a repeating unit represented by the following Structural Formula (2).

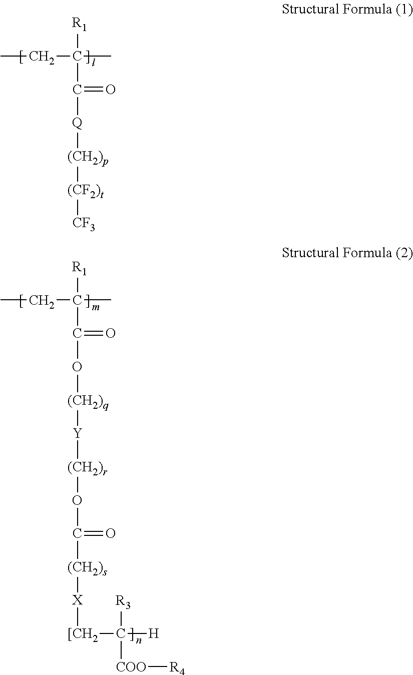

In Structural Formulae (1) and (2), l, m and n each independently represent an integer equal to or larger than 1; p, q, r and s each independently represent 0 or an integer equal to or larger than 1; t represents an integer of 1 to 7; R₁, R₂, R₃ and R₄ each independently represent a hydrogen atom or an alkyl group; X represents an alkylene chain, a halogen-substituted alkylene chain, —S—, —O—, —NH— or a single bond; Y represents an alkylene chain, a halogen-substituted alkylene chain, —(C_{z}H_{2z-1}(OH))— or a single bond; z represents an integer equal to or larger than 1; and Q represents —O— or —NH—.

The use of the copolymer that contains the repeating unit represented by Structural Formula (1) and the repeating unit represented by Structural Formula (2) as the fluoro-alkyl group-containing copolymer may facilitate to improve the dispersability of the fluoro-resin particles in the coating liquid when the overcoat layer is formed and to suppress flocculation of the fluoro-resin particles. Therefore, the fluoro-resin particles may keep a state of small particle size, and the opportunity at which the fluoro-resin particles expose to the outermost surface may be increased. As a result, the ratio of fluorine atom present in the outermost surface of the overcoat layer may be regulated within the range of from approximately 0.1% by mass to approximately 20% by mass.

### Configuration of Photoreceptor

The layer configuration of the photoreceptor according to the exemplary embodiment is not particularly limited as long as the photoreceptor has at least a photosensitive layer on a substrate and an overcoat layer of the photoreceptor contains at least:

(A) the cross-linked component that is obtained by cross-linking of at least one selected from a guanamine compound or a melamine compound and a charge-transporting material having at least one substituent group selected from —OH, —OCH3, —NH2, —SH, or —COOH;

(B) the fluoro-resin particles; and

(C) the fluoro-alkyl group-containing copolymer, and the ratio of fluorine atom present in the outermost surface of the overcoat layer as measured with energy dispersive X-ray analysis (EDS) is from approximately 1.0% by mass to approximately 20.0% by mass.

In embodiments, the photosensitive layer according to the exemplary embodiment may be a function-hybridized photoreceptor that possesses both charge-transporting function and charge-generating function or in embodiments, it may be a function separated photoreceptor that is composed of a charge-transporting layer and a charge-generating layer. In embodiments, the photoreceptor may further contain other layers such as an undercoat layer.

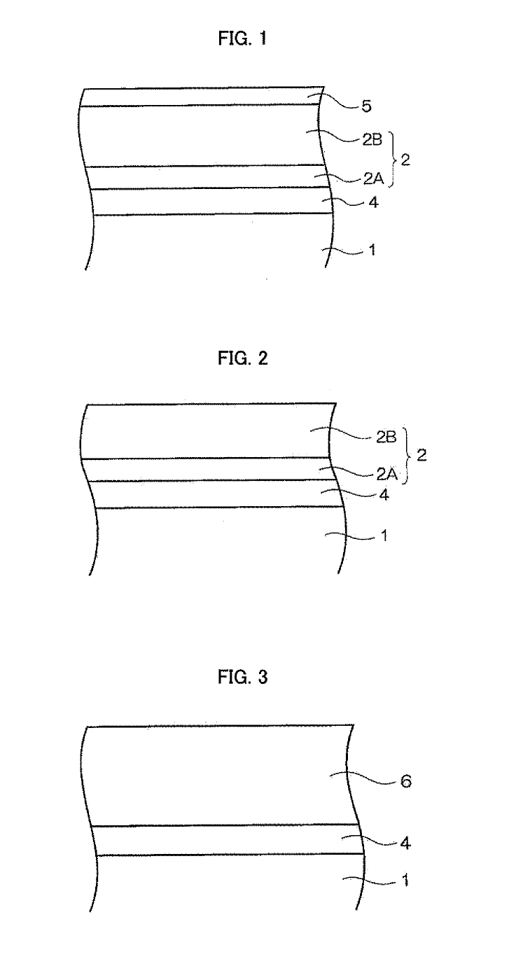

Hereinafter, the configuration of a photoreceptor according to an exemplary embodiment will be described in reference to FIG. 1 to FIG. 3, but it is construed that the exemplary embodiment is not limited by FIG. 1 to FIG. 3.

FIG. 1 is a schematic cross-sectional view showing one exemplary embodiment of layer configuration of the photoreceptor. The photoreceptor shown in FIG. 1 has a layer configuration in which an undercoat layer 4, a charge-generating layer 2A, a charge-transporting layer 2B, and a protective layer 5 are stacked in this order on a substrate 1. The photosensitive layer 2 has two layers, namely the charge-generating layer 2A and the charge-transporting layer 2B (first exemplary embodiment).

In the photoreceptor shown in FIG. 1, the protective layer 5 serves as the overcoat layer. The protective layer 5 contains the essential components of (A) and (B) and satisfies the numerical range of the ratio of fluorine atom present in the outermost surface.

FIG. 2 is a schematic cross-sectional view showing another exemplary embodiment of layer configuration of the photoreceptor. The reference marks shown in FIG. 2 are the same as those shown in FIG. 1.

The photoreceptor shown in FIG. 2 has a layer configuration in which an undercoat layer 4, a charge-generating layer 2A, and a charge-transporting layer 2B are stacked in this order on a substrate 1. The photosensitive layer 2 has two layers, namely the charge-generating layer 2A and the charge-transporting layer 2B (second exemplary embodiment).

In the photoreceptor shown in FIG. 2, the charge-transporting layer 2B serves as the overcoat layer. The charge-transporting layer 2B contains the essential components of (A) and (B) and satisfies the numerical range of the ratio of fluorine atom present in the outermost surface.

FIG. 3 is a schematic cross-sectional view showing another exemplary embodiment of layer configuration of the photoreceptor. In FIG. 3, the reference mark “6” represents a function-hybridized photosensitive layer, and the other reference marks are the same as those shown in FIG. 1.

The photoreceptor shown in FIG. 3 has a layer configuration in which an undercoat layer 4 and a photosensitive layer 6 are stacked in this order on a substrate 1. The photosensitive layer 6 is a layer in which the functions of the charge-generating layer 2A and the charge-transporting layer 2B that are shown in FIG. 1 are hybridized (third exemplary embodiment).

In the photoreceptor shown in FIG. 3, the function-hybridized photosensitive layer 6 serves as the overcoat layer. The photosensitive layer 6 contains the essential components of (A) and (B) and satisfies the numerical range of the ratio of fluorine atom present in the outermost surface.

Hereinafter, each of the first to third exemplary embodiment of the photoreceptor will be explained.

First Exemplary Embodiment of Photoreceptor (Exemplary Embodiment in which the Overcoat Layer is a Protective Layer)

A photoreceptor according to the first exemplary embodiment of the first aspect has, as shown in FIG. 1, the undercoat layer 4, the charge-generating layer 2A, the charge-transporting layer 2B, and the protective layer 5 are stacked on the substrate 1 in this order to form a layer configuration, and the protective layer 5 serves as the overcoat layer.

Substrate

A substrate having the conductivity is employed as the substrate 1. Examples of the substrate include metal plates, metal drums, and metal belts using metals such as aluminum, copper, zinc, stainless steel, chromium, nickel, molybdenum, vanadium, indium, gold, platinum or alloys thereof, and papers, plastic films and belts which are coated, deposited, or laminated with a conductive compound such as a conductive polymer and indium oxide, a metal such as aluminum, palladium and gold, or alloys thereof. The term “conductive” means that the volume resistivity is less than 10¹³ Ωcm.

When the electrophotographic photoreceptor of the first exemplary embodiment is used in a laser printer, the surface of the substrate 1 is preferably roughened so as to have a centerline average roughness (Ra) of 0.04 μm to 0.5 μm. When an incoherent light source is used, surface roughening is not necessary.

Examples of the method for surface roughening include wet honing in which an abrasive suspended in water is blown onto a support, centerless grinding in which a support is continuously ground by pressing the support onto a rotating grind stone, and anodic oxidation.

Examples of the method for surface roughening further include a method of surface roughening by forming on the substrate surface a layer of resin in which conductive or semiconductive particles are dispersed in the resin so that the surface roughening is achieved by the particles dispersed in the layer, without roughing the surface of the substrate 1.

In the surface-roughening treatment by anodic oxidation, an oxide film is formed on an aluminum surface by anodic oxidation in which the aluminum as anode is anodized in an electrolyte solution. Examples of the electrolyte solution include a sulfuric acid solution and an oxalic acid solution. However, the porous anodic oxide film formed by anodic oxidation without modification is chemically active, easily contaminated and has a large resistance variation depending on the environment. Therefore, it is preferable to conduct a sealing treatment in which fine pores of the anodic oxide film are sealed by cubical expansion caused by a hydration in pressurized water vapor or boiled water (to which a metallic salt such as a nickel salt may be added) to transform the anodic oxide into a more stable hydrated oxide. The thickness of the anodic oxide film may be preferably from 0.3 μm to 15 μm.

The substrate 1 may have been subjected to a treatment with an acidic aqueous solution or a boehmite treatment.

The treatment with an acidic treatment solution comprising phosphoric acid, chromic acid and hydrofluoric acid is carried out as follows: phosphoric acid, chromic acid, and hydrofluoric acid are mixed to prepare an acidic treatment solution preferably in a mixing ratio of 10% by mass to 11% by mass of phosphoric acid, 3% by mass to 5% by mass of chromic acid, and 0.5% by mass to 2% by mass of hydrofluoric acid. The concentration of the total acid components may be preferably in the range of 13.5% by mass to 18% by mass. The treatment temperature may be preferably 42° C. to 48° C. The thickness of a coating film formed thereby may be preferably from 0.3 μm to 15 μm.

The boehmite treatment may be carried out by immersing the substrate in pure water at a temperature of 90 to 100° C. for 5 to 60 minutes, or by bringing it into contact with heated water vapor at a temperature of 90° C. to 120° C. for 5 to 60 minutes. The thickness of a coating film formed thereby may be more preferably 0.1 μm to 5 μm. The film may further be subjected to anodic oxidation using an electrolyte solution which sparingly dissolves the film, such as adipic acid, boric acid, borate salt, phosphate, phthalate, maleate, benzoate, tartrate, and citrate solutions.

Undercoat Layer

The undercoat layer 4 has a configuration in which, for example, inorganic particles are contained in a binding resin.

The inorganic particles preferably have powder resistance (volume resistivity) of about 10² Ω·cm to about 10¹¹ Ω·cm.

Examples of the inorganic particles having this resistance value include inorganic particles of tin oxide, titanium oxide, zinc oxide, and zirconium oxide, and in embodiments, zinc oxide may be preferably used.

The inorganic particles may be the ones which have been subjected to a surface treatment. Particles which are subjected to different surface treatments, or those having different particle diameters, may be used in combination of two or more kinds. In embodiments, the volume-average diameter of the inorganic particles may be from 50 nm to 2,000 nm, and may be preferably from 60 nm to 1,000 nm.

In embodiments, inorganic particles having a specific surface area (measured by a BET analysis) of 10 m²/g or more may be preferably used.

In embodiments, in addition to the inorganic particles, acceptive compounds may be included in the undercoat layer. Any acceptive compound may be used in the undercoat layer, and examples thereof include electron transporting substances such as quinone compounds such as chloranil and bromanil, tetracyanoquinodimethane compounds, fluorenone compounds such as 2,4,7-trinitrofluorenone and 2,4,5,7-tetranitro-9-fluorenone, oxadiazole compounds such as 2-(4-biphenyl)-5-(4-t-butylphenyl)-1,3,4-oxadiazole, 2,5-bis(4-naphthyl)-1,3,4-oxadiazole, and 2,5-bis(4-diethylaminophenyl)-1,3,4-oxadiazole, xanthone compounds, thiophene compounds and diphenoquinone compounds such as 3,3′2,5,5′-tetra-t-butyldiphenoquinone. In embodiments, compounds having an anthraquinone structure may be preferably used. Examples of the acceptive compound further include those having an anthraquinone structure such as hydroxyanthraquinone compounds, aminoanthraquinone compounds, and aminohydroxyanthraquinone compounds, and specific examples thereof include anthraquinone, alizarin, quinizarin, anthrarufin, and purpurin.

The content of the acceptive compound may be determined as appropriate. In embodiments, it may be preferably in the range of 0.01% by mass to 20% by mass, and more preferably in the range of 0.05% by mass to 10% by mass, with respect to the content of the inorganic particles.

The acceptor compound may simply be added at the time of application of the undercoat layer 4, or may be previously attached to the surface of the inorganic particles. Examples of the method of attaching the acceptor compound to the surface of the inorganic particles include a dry method and a wet method.

When a surface treatment is conducted according to a dry method, the acceptor compound is added dropwise to the inorganic particles or sprayed thereto together with dry air or nitrogen gas, either directly or in the form of a solution in which the acceptor compound is dissolved in an organic solvent, while the inorganic particles are stirred with a mixer or the like having a high shearing force. The addition or spraying may be preferably carried out at a temperature lower than the boiling point of the solvent. After the addition or spraying of the acceptor compound, the inorganic particles may further be subjected to baking at a temperature of 100° C. or higher. The baking may be carried out as appropriate at a temperature and timing.

When a surface treatment is conducted according to a wet method, the inorganic particles are dispersed in a solvent by means of stirring, ultrasonic wave, a sand mill, an attritor, a ball mill or the like, then the acceptor compound is added and the mixture is further stirred or dispersed, thereafter the solvent is removed, and thereby the particles are surface-treated. The solvent is removed by filtration or distillation. After removing the solvent, the particles may be subjected to baking at a temperature of 100° C. or higher. The baking can be carried out at any temperature and timing. In the wet method, the moisture contained in the inorganic particles may be removed prior to adding the surface treatment agent. The moisture can be removed by, for example, stirring and heating the particles in the solvent used for the surface treatment, or by azeotropic removal with the solvent.

The inorganic particles may be subjected to a surface treatment prior to the addition of the acceptor compound. The surface treatment agent may be selected from known materials. Examples thereof include silane coupling agents, titanate coupling agents, aluminum coupling agents and surfactants. Among these, silane coupling agents may be preferably used, and silane coupling agents having an amino group may be more preferably used.

The silane coupling agents having amino groups may be any compounds. Specific examples thereof include γ-aminopropyltriethoxysilane, N-β-(aminoethyl)-γ-aminopropyltrimethoxysilane, N-β-(aminoethyl)-γ-aminopropylmethydilmethoxysilane, and N,N-bis(β-hydroxyethyl)-γ-aminopropyltriethoxysilane, but are not limited thereto.

The silane coupling agent may be used singly or in combination of two or more kinds thereof. Examples of the silane coupling agents which can be used in combination with the silane coupling agents having an amino group include vinyltrimethoxysilane, γ-methacryloxypropyl-tris-(β-methoxyethoxy)silane, β-(3,4-epoxycyclohexyl)ethyltrimethoxysilane, γ-glycidoxypropyltrimethoxysilane, vinyltriacetoxysilane, γ-mercaptopropyltrimethoxysilane, γ-aminopropyltriethoxysilane, N-β-(aminoethyl)-γ-aminopropyltrimethoxysilane, N-β-(aminoethyl)-γ-aminopropylmethyldimethoxysilane, N,N-bis(β-hydroxyethyl)-γ-aminopropyltriethoxysilane, and γ-chloropropyltrimethoxysilane, but are not limited thereto.

The surface treatment method may be any known method, and may be preferably a dry method or a wet method. Addition of an acceptor and a surface treatment using a coupling agent or the like may be carried out simultaneously.

The content of the silane coupling agent contained in the undercoat layer 4 may be determined as appropriate. In embodiments, it may be preferably 0.5% by mass to 10% by mass with respect to the content of the inorganic particles in the undercoat layer 4.

Any known resin may be used as the binding resin contained in the undercoat layer 4. Examples thereof include known polymer resin compounds such as acetal resins such as polyvinyl butyral, polyvinyl alcohol resins, casein, polyamide resins, cellulose resins, gelatin, polyurethane resins, polyester resins, methacrylic resins, acrylic resins, polyvinyl chloride resins, polyvinyl acetate resins, vinyl chloride-vinyl acetate-maleic anhydride resins, silicone resins, silicone-alkyd resins, phenolic resins, phenol-formaldehyde resins, melamine resins and urethane resins; charge transporting resins having charge transporting groups; and conductive resins such as polyaniline. Preferable examples thereof include resins which are insoluble in the coating solvent for the upper layer, and more preferable examples thereof include phenolic resins, phenol-formaldehyde resins, melamine resins, urethane resins, and epoxy resins. When these resins are used in combination of two or more kinds, the mixing ratio can be appropriately determined according to the circumstances.

The ratio of the content of the metal oxide imparted with the properties as an acceptor to the content of the binder resin, or the ratio of the content of the inorganic particles to the content of the binder resin, in the coating liquid for forming the undercoat layer, may be appropriately determined.

Various additives may be used for the undercoat layer 4. Examples of the additives include known materials such as electron transporting pigments such as polycyclic condensed electron transporting pigments or azo electron transporting pigments, zirconium chelate compounds, titanium chelate compounds, aluminum chelate compounds, titanium alkoxide compounds, organic titanium compounds, and silane coupling agents. Silane coupling agents, which are used for surface treatment of metal oxides, may also be added to the coating liquid as additives. Specific examples of the silane coupling agents include vinyltrimethoxysilane, γ-methacryloxypropyl-tris(β-methoxyethoxy)silane, β-(3,4-epoxycyclohexyl)ethyltrimethoxysilane, γ-glycidoxypropyltrimethoxysilane, vinyltriacetoxysilane, γ-mercaptopropyltrimethoxysilane, γ-aminopropyltriethoxysilane, N-β-(aminoethyl)-γ-aminopropyltrimethoxysilane, N-β-(aminoethyl)-γ-aminopropylmethyldimethoxysilane, N,N-bis(β-hydroxyethyl)-γ-aminopropyltriethoxysilane, and γ-chloropropyltrimethoxysilane.

Examples of the zirconium chelate compounds include zirconium butoxide, zirconium ethyl acetoacetate, zirconium triethanolamine, acetylacetonate zirconium butoxide, ethyl acetoacetate zirconium butoxide, zirconium acetate, zirconium oxalate, zirconium lactate, zirconium phosphonate, zirconium octanoate, zirconium naphthenate, zirconium laurate, zirconium stearate, isostearic acid zirconium, methacrylate zirconium butoxide, stearate zirconium butoxide, and isostearate zirconium butoxide.

Examples of the titanium chelate compounds include tetraisopropyl titanate, tetranormalbutyl titanate, butyl titanate dimer, tetra(2-ethylhexyl)titanate, titanium acetyl acetonate, polytitaniumacetyl acetonate, titanium octylene glycolate, titanium lactate ammonium salt, titanium lactate, titanium lactate ethyl ester, titanium triethanol aminato, and polyhydroxy titanium stearate.

Examples of the aluminum chelate compounds include aluminum isopropylate, monobutoxy aluminum diisopropylate, aluminum butylate, ethylacetoacetate aluminum diisopropylate, and aluminum tris(ethylacetoacetate).

These compounds may be used alone, or as a mixture or a polycondensate of two or more kinds thereof.

The solvent for preparing the coating liquid for forming the undercoat layer may appropriately be selected from known organic solvents such as alcohol solvents, aromatic solvents, hydrocarbon halide solvents, ketone solvents, ketone alcohol solvents, ether solvents, and ester solvents. Examples thereof include common organic solvents such as methanol, ethanol, n-propanol, iso-propanol, n-butanol, benzyl alcohol, methyl cellosolve, ethyl cellosolve, acetone, methyl ethyl ketone, cyclohexanone, methyl acetate, ethyl acetate, n-butyl acetate, dioxane, tetrahydrofuran, methylene chloride, chloroform, chlorobenzene, and toluene.

These solvents used for dispersing may be used alone or as a mixture of two or more kinds thereof. When they are mixed, any mixed solvents which can solve a binder resin can be used.

Any known device such as a roll mill, a ball mill, a vibration ball mill, an attritor, a sand mill, a colloid mill, or a paint shaker may be used to perform the dispersion. For applying the undercoat layer 4, known methods such as blade coating, wire bar coating, spray coating, dip coating, bead coating, air knife coating, curtain coating or the like may be used.

The undercoat layer 4 may be formed on the substrate 1 using the thus-obtained coating liquid.

The Vickers hardness of the undercoat layer 4 may be preferably 35 or more.

The thickness of the undercoat layer 4 may be arbitrarily determined. In embodiments, it may be preferably 15 μm or more, and more preferably from 15 μm to 50 μm.

The surface roughness of the undercoat layer 4 (ten point-average roughness) may be adjusted in the range of from [1/(4n)]λ to ½λ, where λ represents the wavelength of the laser for exposure and n represents a refractive index of the upper layer, in view of suppressing formation of a moire image. Particles of a resin or the like may be added to the undercoat layer for adjusting the surface roughness. Examples of the resin particles include silicone resin particles and particles of crosslinked polymethyl methacrylate resin.

The undercoat layer may be subjected to polishing for adjusting the surface roughness thereof. Examples of the polishing method include buffing, a sandblast treatment, a wet honing, and a grinding treatment.

The undercoat layer may be obtained by drying the applied coating, which is usually carried out at a temperature at which the solvent evaporates to form a film.

Charge Generating Layer

The charge generating layer 2A is a layer having at least a charge generating material and a binder resin.

Examples of the charge generating material include azo pigments such as bis-azo pigments and tris-azo pigments, condensed aromatic pigments such as dibromoanthanthrone, perylene pigments, pyrrolopyrrole pigments, phthalocyanine pigments, zinc oxide, and trigonal selenium. Among these, metal- or non-metal-phthalocyanine pigments may be favorably used in exposure with near-infrared laser light. Hydroxygallium phthalocyanine disclosed in JP-A Nos. 5-263007 and 5-279591, chlorogallium phthalocyanine disclosed in JP-A No. 5-98181, dichlorotin phthalocyanine disclosed in JP-A Nos. 5-140472 and 5-140473, and titanylphthalocyanine disclosed in JP-A Nos. 4-189873 and 5-43823 may be more favorably used. In exposure with near-ultraviolet laser light, condensed aromatic pigments such as dibromoanthanthrone, thioindigo pigments, porphyrazine compounds, zinc oxide, trigonal selenium or the like may be favorably used. The charge generating material may be preferably an inorganic pigment when an exposure light source with a wavelength of from 380 nm to 500 nm is used, and may be preferably a non-metal phthalcyanine pigment when an exposure light source with a wavelength of from 700 nm to 800 nm is used.

Hydroxygallium phthalozyanine pigments having a maximum peak wavelength in a range of from 810 nm to 839 nm in a spectral absorption spectrum of a wavelength region of from 600 nm to 900 nm may be preferably used as the charge generating material. This hydroxygallium phthalocyanine pigments differ from conventional V-type hydroxygallium phthalocyanine pigments in that the maximum peak wavelength of a spectral absorption spectrum thereof is sifted to be shorter than that of conventional V-type hydroxygallium phthalocyanine pigments.

The hydroxygallium phthalozyanine pigment having a maximum peak wavelength in a range of from 810 nm to 839 nm may preferably have an average particle size and a BET specific surface area in a certain range. Specifically, the average particle diameter may be preferably 0.20 μm or less, and more preferably from 0.01 μm to 0.15 μm, and the BET specific surface area may be preferably 45 m²/g or more, and more preferably 50 m²/g or more, and further preferably from 55 m²/g to 120 m²/g. The average particle size here is a volume average particle size (d50 average particle size) measured by a laser diffraction/scattering type particle size distribution tester (trade name: LA-700, manufactured by Horiba, Ltd.), and the BET specific surface area is measured by a nitrogen substitution method using a BET specific surface area analyzer (trade name: FLOWSORB II 2300, manufactured by Shimadzu Corporation).

The maximum particle size (maximum primary particle size) of the hydroxygallium phthalozyanine pigment may be preferably 1.2 μm or less, more preferably 1.0 μm or less, and further preferably 0.3 μm or less.

The hydroxygallium phthalocyanine pigment may preferably have an average particle size of 0.2 μm or less, a maximum particle size of 1.2 μm or less, and a BET specific surface area of 45 m²/g or more.

The hydroxygallium phthalocyanine pigment may preferably have diffraction peaks at 7.5°, 9.9°, 12.5°, 16.3°, 18.6°, 25.1° and 28.3° of Bragg angles (2±0.2°) in an X-ray diffraction spectrum obtained using CuKα characteristic X rays.

The hydroxygallium phthalocyanine pigment may preferably have a thermogravimetric reduction rate when a temperature is increased from 25° C. to 400° C. of from 2.0% to 4.0%, and more preferably from 2.5% to 3.8%.

The binder resin used in the charge generating layer 2A may be selected from a wide range of insulating resins, and also from organic photoconductive polymers such as poly-N-vinyl carbazole, polyvinyl anthracene, polyvinyl pyrene, and polysilane. Preferable examples of the binder resin include polyvinyl butyral resins, polyarylate resins (polycondensates of bisphenols and aromatic divalent carboxylic acid, or the like), polycarbonate resins, polyester resins, phenoxy resins, vinyl chloride-vinyl acetate copolymers, polyamide resins, acrylic resins, polyacrylamide resins, polyvinyl pyridine resins, cellulose resins, urethane resins, epoxy resins, casein, polyvinyl alcohol resins, and polyvinyl pyrrolidone resins. These binder resins may be used alone or in combination of two or more kinds. The mixing ratio between the charge generating material and the binder resin is preferably in the range of from 10:1 to 1:10 by weight ratio. The term “insulating” herein means that the resin has a volume resistivity of 10¹³ Ωm or more.

The charge generating layer 2A may be formed by, for example, using a coating liquid in which the charge generating material and the binder resin are dispersed in a solvent.

Examples of the solvent used for the dispersing include methanol, ethanol, n-propanol, n-butanol, benzyl alcohol, methyl cellosolve, ethyl cellosolve, acetone, methyl ethyl ketone, cyclohexanone, methyl acetate, n-butyl acetate, dioxane, tetrahydrofuran, methylene chloride, chloroform, chlorobenzene and toluene. These solvents may be used alone or in combination of two or more kinds.

The method of dispersing the charge generating material and the binder resin in a solvent may be any ordinary method such as ball mill dispersing, attritor dispersing or sand mill dispersing. The average particle diameter of the charge generating material to be dispersed may be preferably 0.5 μm or less, more preferably 0.3 μm or less, and further preferably 0.15 μm or less.

The method of forming the charge generating layer 2A may be any conventional method such as blade coating, Meyer bar coating, spray coating, dip coating, bead coating, air knife coating, or curtain coating.

The film thickness of the charge generating layer 2 obtained by this method may be preferably from 0.1 μm to 5.0 μm, and more preferably from 0.2 μm to 2.0 μm.

Charge Transport Layer

The charge transport layer 2B may preferably contain a charge transporting material and a binder resin, or may preferably contain a polymeric charge transporting material.

Examples of the charge transporting material include: electron transporting compounds such as quinone compounds such as p-benzoquinone, chloranil, bromanil and anthraquinone, tetracyanoquinodimethane compounds, fluorenone compounds such as 2,4,7-trinitro fluorenone, xanthone compounds, benzophenone compounds, cyanovinyl compounds, and ethylene compounds; and hole transporting compounds such as triarylamine compounds, benzidine compounds, arylalkane compounds, aryl substituted ethylene compounds, stilbene compounds, anthracene compounds, and hydrazone compounds. These charge transporting materials may be used alone or in combination of two or more kinds thereof, and are not limited thereto.

The charge transporting material may be preferably a triaryl amine derivative represented by the following Formula (a-1) and a benzidine derivative represented by the following Formula (a-2), from the viewpoint of charge mobility.

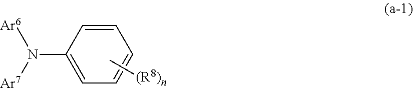

In Formula (a-1), R⁸ represents a hydrogen atom or a methyl group; n represents 1 or 2; Ar⁶ and Ar⁷ each independently represent a substituted or unsubstituted aryl group, —C₆H₄—C(R⁹)═C(R¹⁰)(R¹¹), or —C₆H₄—CH═CH—CH═C(R¹²)(R¹³), wherein R₉ through R₁₃ each independently represent a hydrogen atom, a substituted or unsubstituted alkyl group, or a substituted or unsubstituted aryl group. The substituent is a halogen atom, an alkyl group having 1 to 5 carbon atoms, an alkoxy group having 1 to 5 carbon atoms, or an amino group having an alkyl group having 1 to 3 carbon atoms as a substituent.

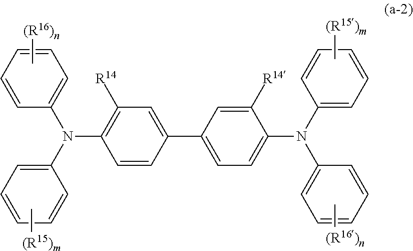

In Formula (a-2), R¹⁴ and R^{14′} may be the same or different from each other, and each independently represent a hydrogen atom, a halogen atom, an alkyl group having 1 to 5 carbon atoms, or an alkoxy group having 1 to 5 carbon atoms; R¹⁵, R^{15′}, R¹⁶ and R^{16′} may be the same or different from each other, and each independently represent a hydrogen atom, a halogen atom, an alkyl group having 1 to 5 carbon atoms, an alkoxy group having 1 to 5 carbon atoms, an amino group having an alkyl group having 1 to 2 carbon atoms as a substituent, a substituted or unsubstituted aryl group, —C(R¹⁷)═C(R¹⁸)(R¹⁹), or —CH═CH—CH═C(R²⁰)(R²¹), wherein R¹⁷ through R²¹ each independently represent a hydrogen atom, a substituted or unsubstituted alkyl group, or a substituted or unsubstituted aryl group, and m and n each independently represent an integer of from 0 to 2.

Among the triarylamine derivatives represented by Formula (a-1) and the benzidine derivatives represented by Formula (a-2), triarylamine derivatives having —C₆H₄—CH═CH—CH═C(R¹²)(R¹³) and benzidine derivatives having —CH═CH—CH═C(R²⁰)(R²¹) may be preferable.

Examples of the binder resin used in the charge transport layer 2B include polycarbonate resins, polyester resins, polyarylate resins, methacrylic resins, acrylic resins, polyvinyl chloride resins, polyvinylidene chloride resins, polystyrene resins, polyvinyl acetate resins, styrene-butadiene copolymers, vinylidene chloride-acrylonitrile copolymers, vinyl chloride-vinyl acetate copolymers, vinyl chloride-vinyl acetate-maleic anhydride copolymers, silicone resins, silicone alkyd resins, phenol-formaldehyde resins, styrene-alkyd resins, poly-N-vinyl carbazole, and polysilane. Further, polymeric charge transporting materials such as the polyester polymer charge transporting materials disclosed in JP-A Nos. 8-176293 and 8-208820 may also be used as the binder resin. These binder resins may be used alone or in combination of two or more kinds. The mixing ratio between the charge transporting material and the binder resin is preferably from 10:1 to 1:5 by weight ratio.

The binder resin is not particularly limited. In embodiments, it may preferably include at least one selected from a polycarbonate resin having a viscosity-average molecular weight of from 50,000 to 80,000 or a polyarylate resin having a viscosity-average molecular weight of from 50,000 to 80,000.

Polymeric charge transport material may also be used as the charge transporting material. As the polymeric charge transporting material, known materials having charge transporting properties such as poly-N-vinyl carbazole and polysilane may be used. In embodiments, polyester polymeric charge transporting materials disclosed in JP-A Nos. 8-176293 and 8-208820, having higher charge transporting properties than that of other species, may be preferably used. The charge transporting polymer material forms a film by itself, but may also be mixed with the above-described binder resin to form a film.

The charge transport layer 2B may be formed using the coating liquid containing the component materials explained above. Examples of the solvent used for the coating liquid for forming the charge transport layer include ordinary organic solvents such as aromatic hydrocarbons such as benzene, toluene, xylene and chlorobenzene; ketones such as acetone and 2-butanone; aliphatic hydrocarbon halides such as methylene chloride, chloroform and ethylene chloride; and cyclic or straight-chained ethers such as tetrahydrofuran and ethyl ether. These solvents may be used alone or in combination of two or more kinds. As the method for dispersing the component materials, known methods may be used.

As the method for applying the coating liquid for forming the charge transport layer onto the charge generating layer 2, ordinary methods such as blade coating, Meyer bar coating, spray coating, dip coating, bead coating, air knife coating and curtain coating may be used.

The film thickness of the charge transport layer 2B may be preferably from 5 μm to 50 μm, and more preferably from 10 μm to 30 μm.

Protective Layer

The protective layer 5 is an overcoat layer of the electrophotographic photoreceptor of the first exemplary embodiment. The protective layer 5 that is the overcoat layer of the electrophotographic photoreceptor of the first exemplary embodiment contains at least:

(A) a cross-linked component that is obtained by cross-linking of at least one selected from a guanamine compound or a melamine compound and a charge-transporting material having at least one substituent group selected from —OH, —OCH₃, —NH₂, —SH, or —COOH;

(B) fluoro-resin particles;

(C) a fluoro-alkyl group-containing copolymer; and

(D) optional other component,

and the ratio of fluorine atom present in the outermost surface of the overcoat layer as measured with energy dispersive X-ray analysis (EDS) is from approximately 1.0% by mass to approximately 20.0% by mass.

(A) Cross-Linked Component

The protective layer 5 that is the overcoat layer of the electrophotographic photoreceptor of the first exemplary embodiment contains at least the (A) cross-linked component that is obtained by cross-linking of at least one selected from a guanamine compound or a melamine compound and a charge-transporting material having at least one substituent group selected from —OH, —OCH₃, —NH₂, —SH, or —COOH (hereinafter referred to as a “specific charge-transporting material” in some cases). In embodiments, the ratio of the sum of the content of the guanamine compound and the content of the melamine compound to the total solid content of the overcoat layer excluding the content of the fluoro-resin particles and the content of the fluoro-alkyl group-containing copolymer may be preferably from approximately 0.1% by mass to approximately 20% by mass, and the ratio of the content of the specific charge-transporting material to the total solid content of the overcoat layer excluding the content of the fluoro-resin particles and the content of the fluoro-alkyl group-containing copolymer may be preferably from approximately 80% by mass to approximately 99.9% by mass.

Guanamime Compound

The guanamime compound is a compound having a guanamine skeleton (structure), and examples thereof include acetoguanamine, benzoguanamine, formguanamine, steroguanamine, spiroguanamine, and cyclohexylguanamine.

The guanamine compound may be preferably at least one of the compound represented by the following Formula (A) or a polymer thereof. The polymer herein refers to an oligomer which is obtained by polymerizing the compound represented by Formula (A) as a structural unit and has a polymerization degree of, for example, from 2 to 200, preferably from 2 to 100. The compound represented by Formula (A) may be used alone or as a mixture of two or more kinds thereof.

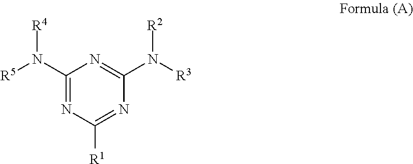

In Formula (A), R¹ represents a linear or branched alkyl group having 1 to 10 carbon atoms, a substituted or unsubstituted phenyl group having 6 to 10 carbon atoms, or a substituted or unsubstituted alicyclic hydrocarbon group having 4 to 10 carbon atoms, and R² through R⁵ each independently represent a hydrogen atom, —CH₂—OH or —CH₂—O—R⁶ wherein R⁶ represents a hydrogen atom or a linear or branched alkyl group having 1 to 10 carbon atoms.

In Formula (A), the alkyl group represented by R¹ has 1 to 10 carbon atoms, preferably has 1 to 8 carbon atoms, and more preferably has 1 to 5 carbon atoms. The alkyl group may be either linear or branched.

In Formula (A), the phenyl group represented by R¹ has 6 to 10 carbon atoms, and preferably has 6 to 8 carbon atoms. Examples of the substituent that may substitute the phenyl group include a methyl group, an ethyl group, and a propyl group.

In Formula (A), the alicyclic hydrocarbon group represented by R¹ has 4 to 10 carbon atoms, and may preferably has 5 to 8 carbon atoms. Examples of the substituent that may substitute the alicyclic hydrocarbon group include a methyl group, an ethyl group, and a propyl group.

In Formula (A), the alkyl group represented by R⁶ in “—CH₂—O—R⁶” represented by R² through R⁵ has 1 to 10 carbon atoms, preferably has 1 to 8 carbon atoms, and more preferably has 1 to 6 carbon atoms. The alkyl group may be either linear or branched. Preferable examples of the alkyl group represented by R₆ include a methyl group, an ethyl group, and a butyl group.

The compound represented by Formula (A) may be preferably a compound in which R¹ represents a substituted or unsubstituted phenyl group having 6 to 10 carbon atoms, and R² through R⁵ each independently represent —CH₂—O—R⁶. R₆ may be preferably selected from a methyl group or an n-butyl group.

The compound represented by Formula (A) may be synthesized from, for example, guanamine and formaldehyde by a known method such as that described on page 430 of Jikken Kagaku Koza, Fourth edition, Vol. 28, the disclosure of which is incorporated by reference herein.

The following are specific examples of the compound represented by Formula (A), but the invention is not limited to these examples. The following specific examples are described in the form of a monomer, but the compound may be in the form of a polymer (oligomer) having the monomer as a structural unit.

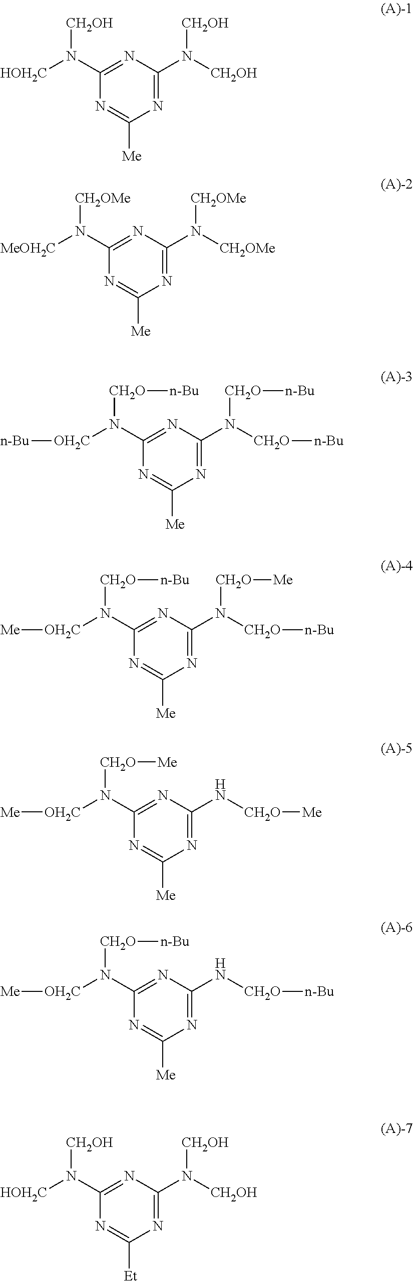

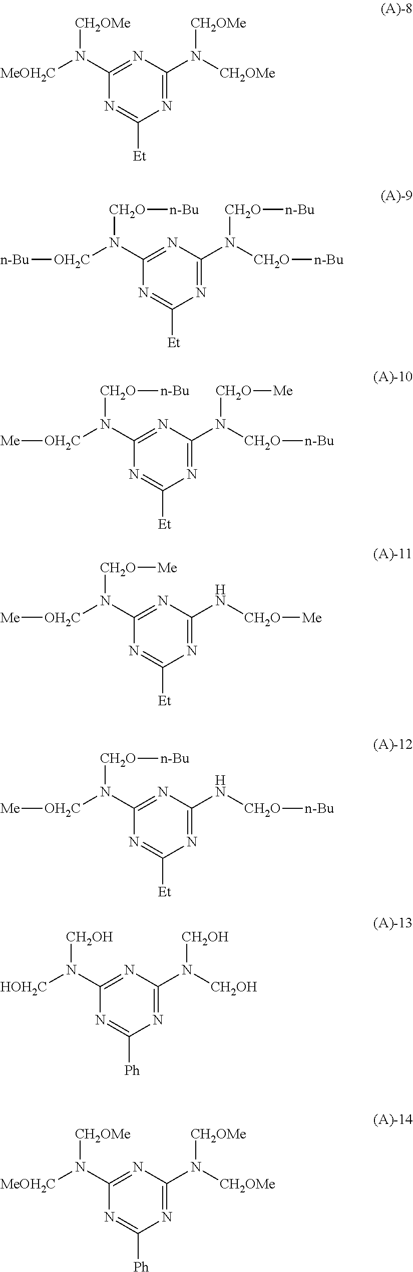

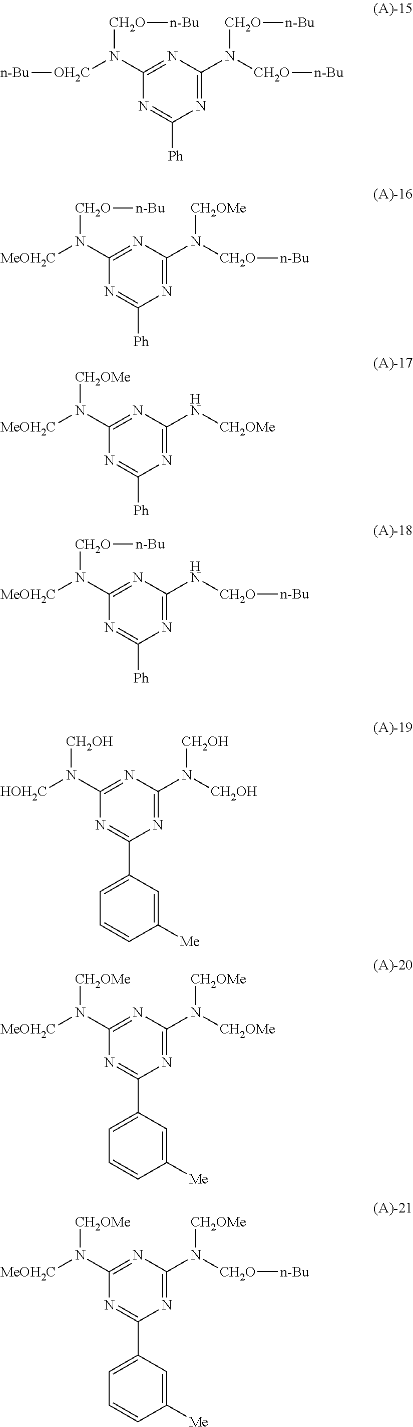

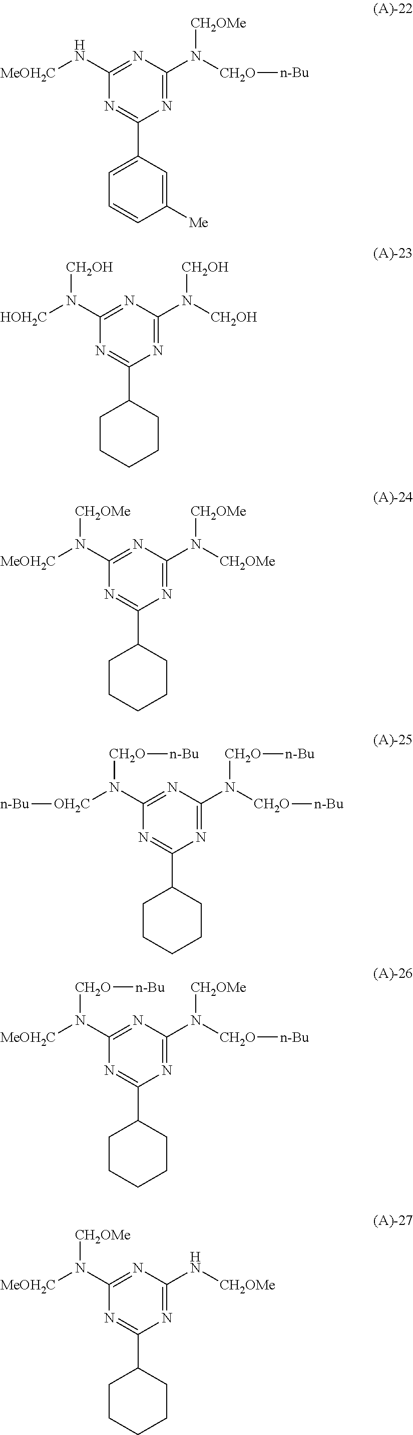

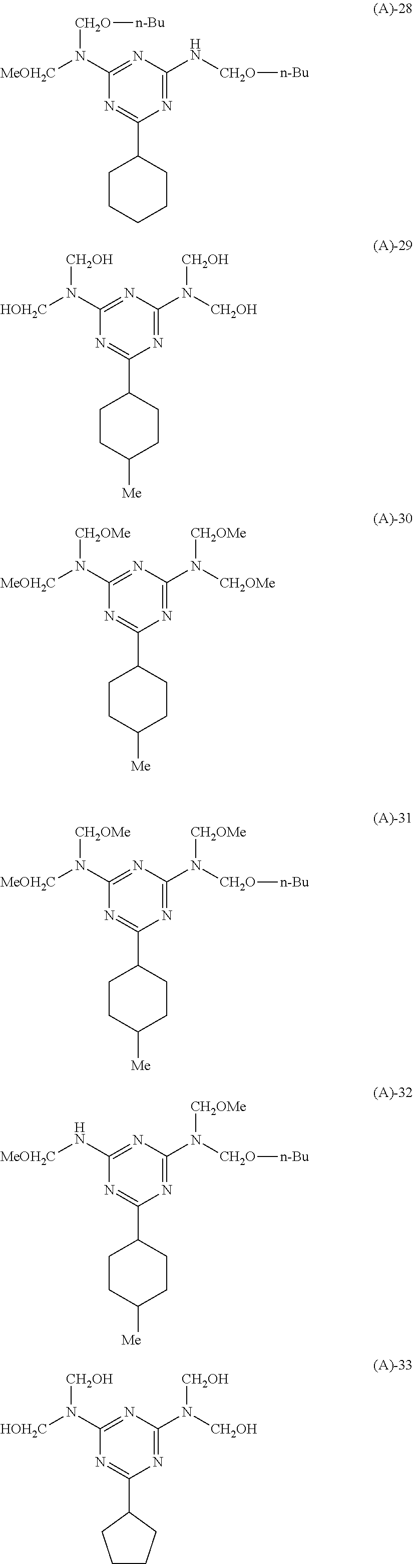

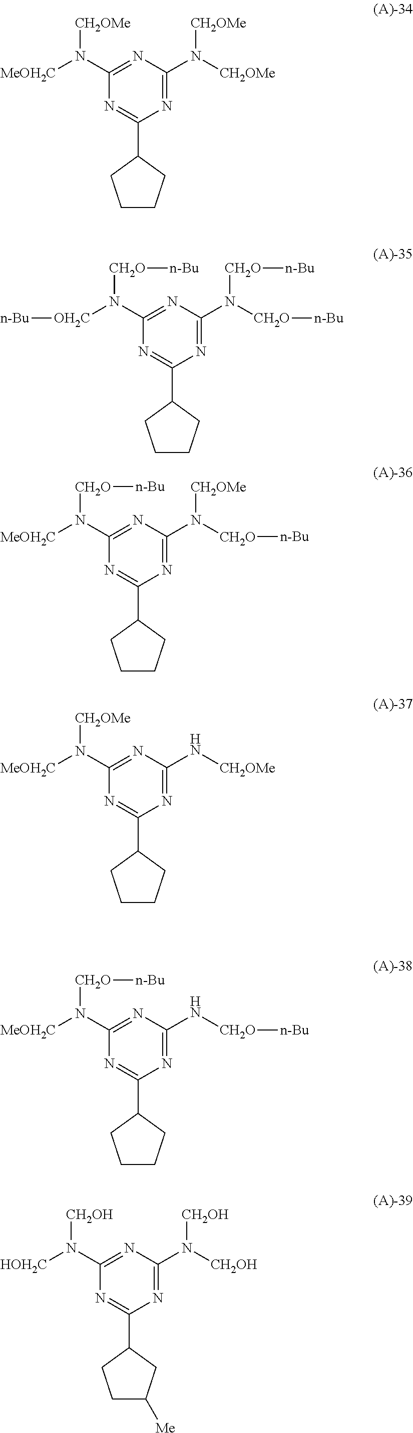

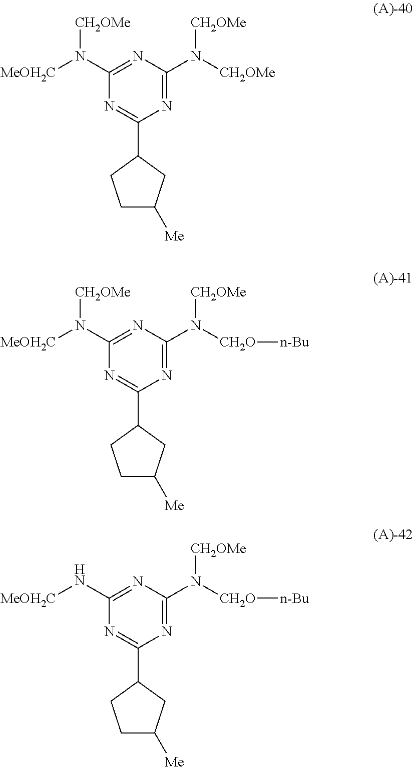

Examples of commercial products of the compound represented by Formula (A) include SUPER BECKAMIN (R) L-148-55, SUPER BECKAMIN (R) 13-535, SUPER BECKAMIN (R) L-145-60 and SUPER BECKAMIN (R) TD-126 (all trade names, manufactured by DIC Inc.), and NIKALACK BL-60 and NIKALACK BX-4000 (all trade names, manufactured by Nippon Carbide Industries Co., Inc.).

In order to remove the influence of the residual catalyst, the compound represented by Formula (A) (including a polymer thereof) obtained by synthesizing or purchasing may then be dissolved in an appropriate solvent such as toluene, xylene or ethyl acetate, and washed with distilled water or ion exchanged water, or may be treated with an ion exchange resin.

Melamine Compound

The melamine compound is a compound having a melamine skeleton (structure) and may be preferably at least one of the compound represented by the following Formula (B) and a polymer thereof. The polymer here refers to an oligomer which is obtained by polymerizing the compound represented by Formula (B) as a structural unit and has a polymerization degree of, for example, from 2 to 200, preferably from 2 to 100. The compound represented by Formula (B) may be used alone or as a mixture of two or more kinds thereof, or may be used in combination with the compound represented by Formula (A) or a polymer thereof.

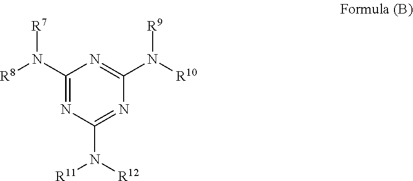

In Formula (B), R⁷ through R¹² each independently represent a hydrogen atom, —CH₂—OH or —CH₂—O—R¹³ wherein R¹³ represents a linear or branched alkyl group having 1 to 5 carbon atoms. Examples of the alkyl group include a methyl group, an ethyl group and a butyl group.

The compound represented by Formula (B) may be synthesized from, for example, melamine and formaldehyde by a known method such as that described on page 430 of Jikken Kagaku Koza, Fourth edition, Vol. 28.

The following are specific examples of the compound represented by Formula (B), but the invention is not limited to these examples. The following specific examples are described in the form of a monomer, but the compound may be in the form of a polymer (oligomer) having the monomer as a structural unit.

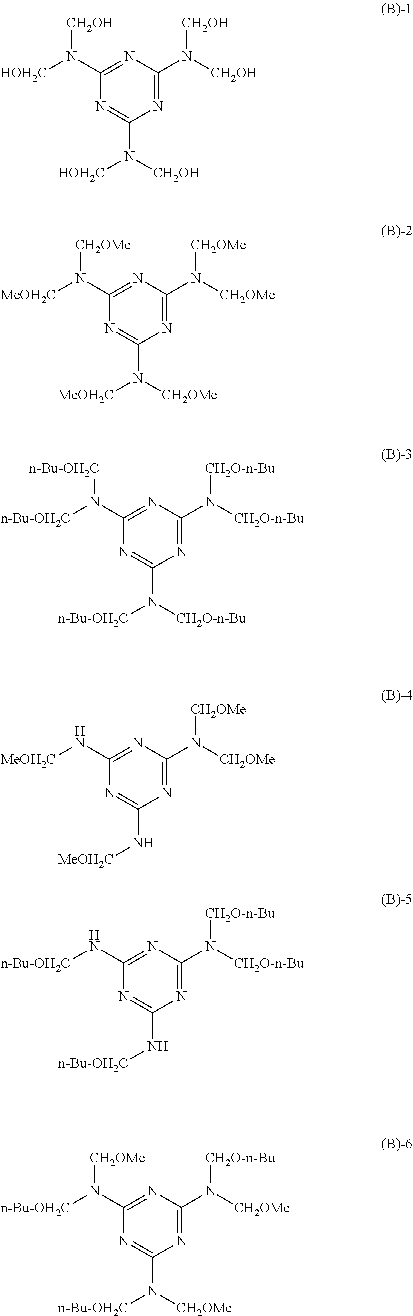

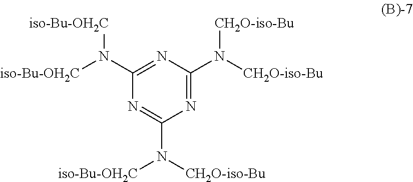

Examples of commercial products of the compound represented by Formula (B) include SUPER MELAMI No. 90 (trade name, manufactured by NOF Corporation), SUPER BECKAMIN (R) TD-139-60 (trade name, manufactured by DIC Inc.), UBAN 2020 (trade name, manufactured by Mitsui Chemicals, Inc.), SUMITEX RESIN M-3 (trade name, manufactured by Sumitomo Chemical Co., Ltd.) and NIKALACK MW-30 (trade name, manufactured by Nippon Carbide Industries Co., Inc.).

In order to remove the influence of the residual catalyst, the compound represented by Formula (B) (including a polymer thereof) obtained by synthesizing or purchasing may then be dissolved in an appropriate solvent such as toluene, xylene or ethyl acetate, and washed with distilled water or ion exchanged water, or may be treated with an ion exchange resin.

Specific Charge Transport Material

The specific charge transporting material has at least one substituent selected from the group consisting of —OH, —OCH₃, —NH₂, —SH, or —COOH, which may be referred to as “specific reactive functional groups”. The specific charge transporting material particularly preferably has at least two (or even more preferably three) substituents selected from the specific reactive functional groups.

The specific charge transporting material may be preferably the compound represented by the following Formula (I):

F_{H}—((—R¹⁴—X)ₙ₁(R¹⁵)ₙ₃—Y)ₙ₂ Formula (I)

In Formula (i), F_{H} represents an organic group derived from a compound having a hole transporting ability; R¹⁴ and R¹⁵ each independently represent a linear or branched alkylene group having 1 to 5 carbon atoms; n1 represents 0 or 1; n2 represents an integer of 1 to 4; n3 represents 0 or 1; X represents an oxygen atom, NH, or a sulfur atom; and Y represents —OH, —OCH₃, —NH₂, —SH, or —COOH (namely, one of the specific reactive functional groups).

In Formula (I), the compound having a hole transporting ability from which the organic group represented by F_{H} is derived is preferably an arylamine derivative. Preferable examples of the arylamine derivative include triphenylamine derivatives and tetraphenylbenzidine derivatives.

The compound represented by Formula (I) may be preferably the compound represented by the following Formula (II).

Formula (II)

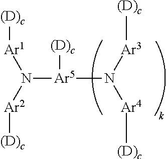

In Formula (II), Ar¹ through Ar⁴ may be the same or different from each other and each independently represent a substituted or unsubstituted aryl group; Ar⁵ represents a substituted or unsubstituted aryl group or a substituted or unsubstituted arylene group; D represents —(—R¹—X)ₙ₁(R²)ₙ₃—Y; c represents 0 or 1; k represents 0 or 1; the total number of D is 1 to 4; R¹ and R² each independently represent a linear or branched alkylene group having 1 to 5 carbon atoms; n1 represents 0 or 1; n3 represents 0 or 1; X represents an oxygen atom, NH, or a sulfur atom; and Y represents —OH, —OCH₃, —NH₂, —SH, or —COOH.

In Formula (II), “—(—R¹—X)ₙ₁(R²)ₙ₃—Y” represented by D is defined in the same manner as in Formula (I), R¹ and R² each independently represent a linear or branched alkylene group having 1 to 5 carbon atoms, n1 is preferably 1, X is preferably an oxygen atom, and Y is preferably a hydroxyl group.

The total number of D in Formula (II) corresponds to n2 in Formula (I), which is preferably from 2 to 4 and more preferably from 3 to 4. Namely, a compound represented by Formula (I) or (II) preferably has from 2 to 4, more preferably has from 3 to 4, of the specific reactive functional groups per molecule.

In Formula (II), Ar¹ through Ar⁴ are preferably represented by any one selected from the formulae (1) through (7). In the following, the formulae (1) through (7) are shown with “-(D)_{c}” which may be linked to each of Ar₁ through Ar₄.

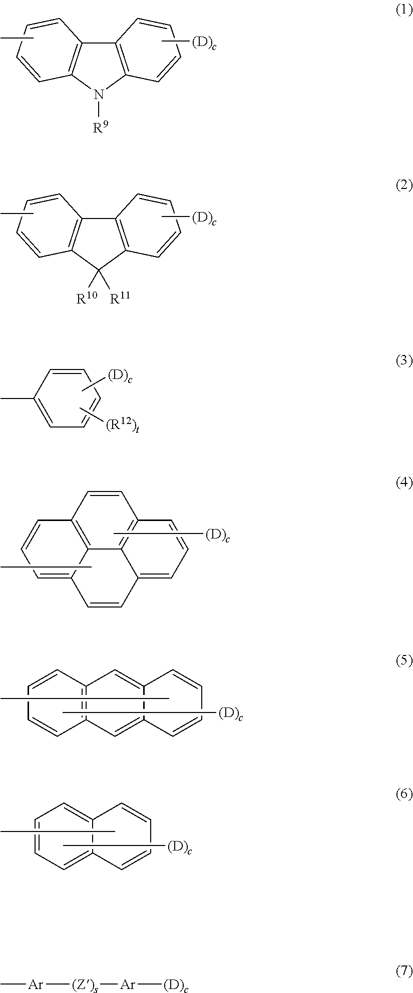

In formulae (1) and (7), R⁹ represents a hydrogen atom, an alkyl group having 1 to 4 carbon atoms, a phenyl groups having an alkyl group having 1 to 4 carbon atoms or an alkoxy group having 1 to 4 carbon atom as a substituent thereof, an unsubstituted phenyl group, or an aralkyl group having 7 to 10 carbon atoms; R¹⁰ through R¹² each independently represent a hydrogen atom, an alkyl group having 1 to 4 carbon atoms, an alkoxy group having 1 to 4 carbon atoms, a phenyl group having an alkoxy group having 1 to 4 carbon atoms as a substituent thereof, an unsubstituted phenyl group, an aralkyl group having 7 to 10 carbon atoms, or a halogen atom; Ar represents a substituted or unsubstituted arylene group; D and c are defined in the same manner as “D” and “c” in Formula (II); s represents 0 or 1; and t represents an integer of from 1 to 3.

In formula (7), Ar preferably represents the following formula (8) or (9).

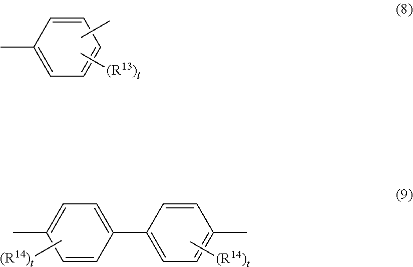

In formulae (8) and (9), R¹³ and R¹⁴ each independently represent a hydrogen atom, an alkyl group having 1 to 4 carbon atoms, an alkoxy group having 1 to 4 carbon atoms, a phenyl group having an alkoxy group having 1 to 4 carbon atoms as a substituent thereof, an unsubstituted phenyl group, an aralkyl group having 7 to 10 carbon atoms, or a halogen atom; and t represents an integer of from 1 to 3.

In formula (7), Z′ preferably represents one selected from the following formulae (10) through (17).

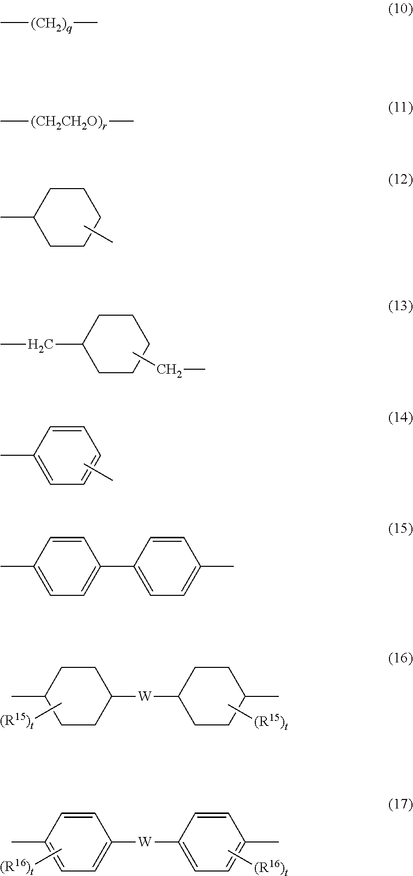

In formulae (10) through (17), R¹⁵ and R¹⁶ each independently represent a hydrogen atom, an alkyl group having 1 to 4 carbon atoms, an alkoxy group having 1 to 4 carbon atoms, a phenyl group having an alkoxy group having 1 to 4 carbon atoms as a substituent thereof, an unsubstituted phenyl group, an aralkyl group having 7 to 10 carbon atoms, or a halogen atom; W represents a divalent group; q and r each independently represent an integer of from 1 to 10; and t represents an integer of from 1 to 3.

In formulae (16) and (17), W is preferably a divalent group represented by any one of the following formulae (18) through (26). In formula (25), u represents an integer of from 0 to 3.

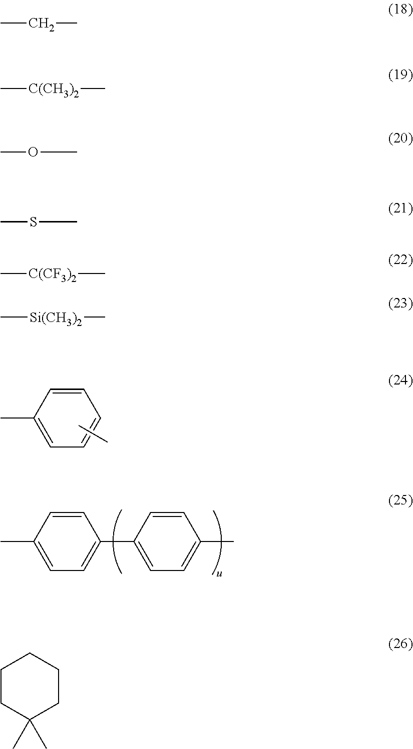

In Formula (II), when k is 0, Ar⁵ preferably corresponds to the aryl group represented by Ar¹ through Ar⁴ in the formulae (1) through (7); and when k is 1, Ar⁵ preferably corresponds to an arylene group obtained by removing a hydrogen atom from the aryl group represented by Ar¹ through Ar⁴ in the formulae (1) through (7).

Specific examples of the compound represented by Formula (I) include the following compounds I-1 through I-34, but the invention is not limited to the following examples.

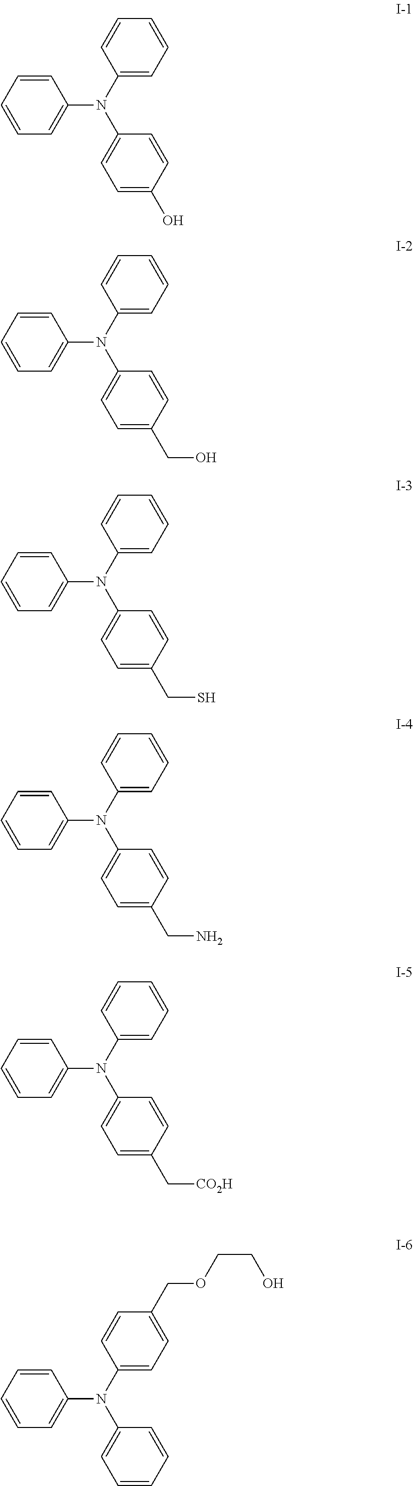

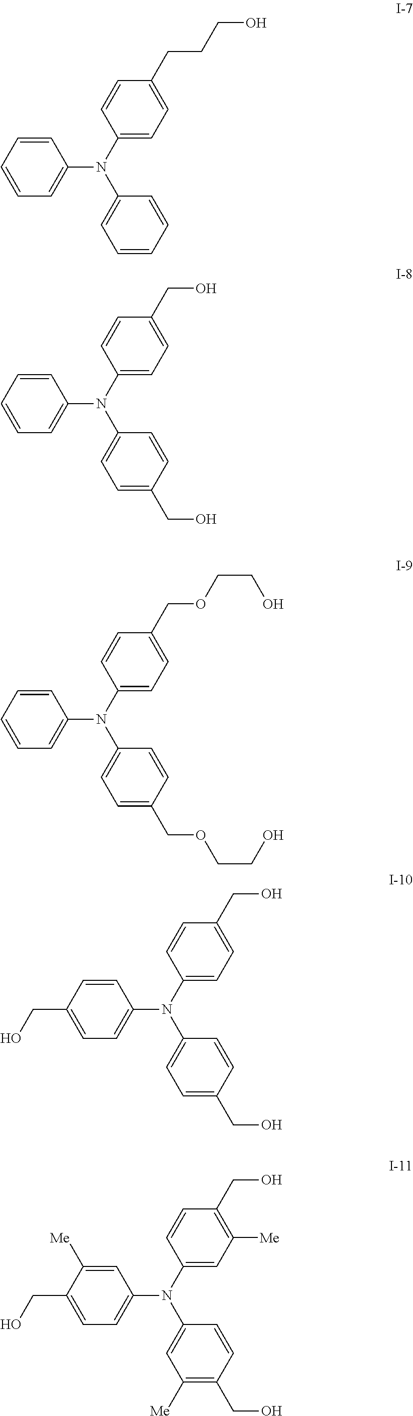

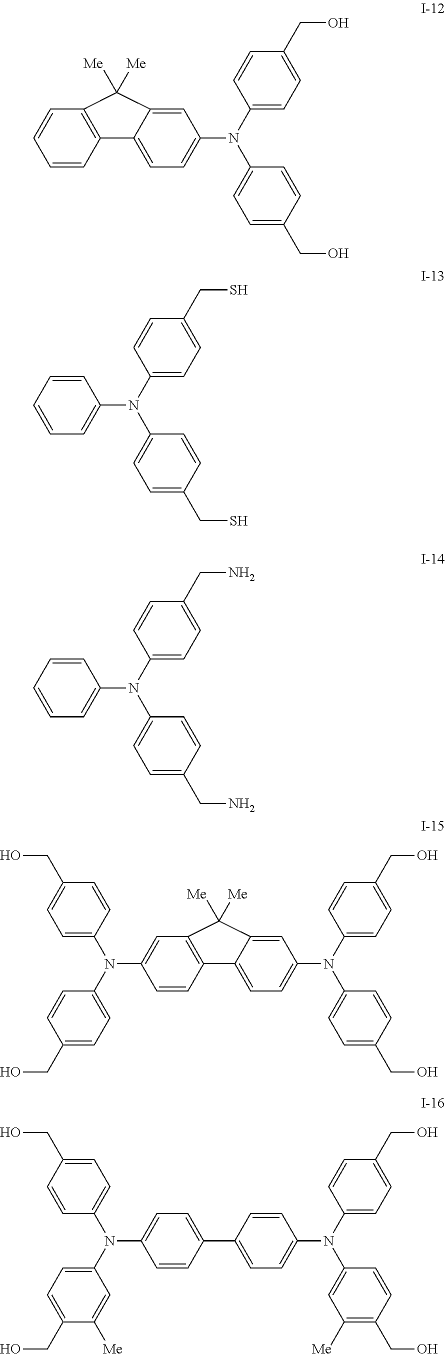

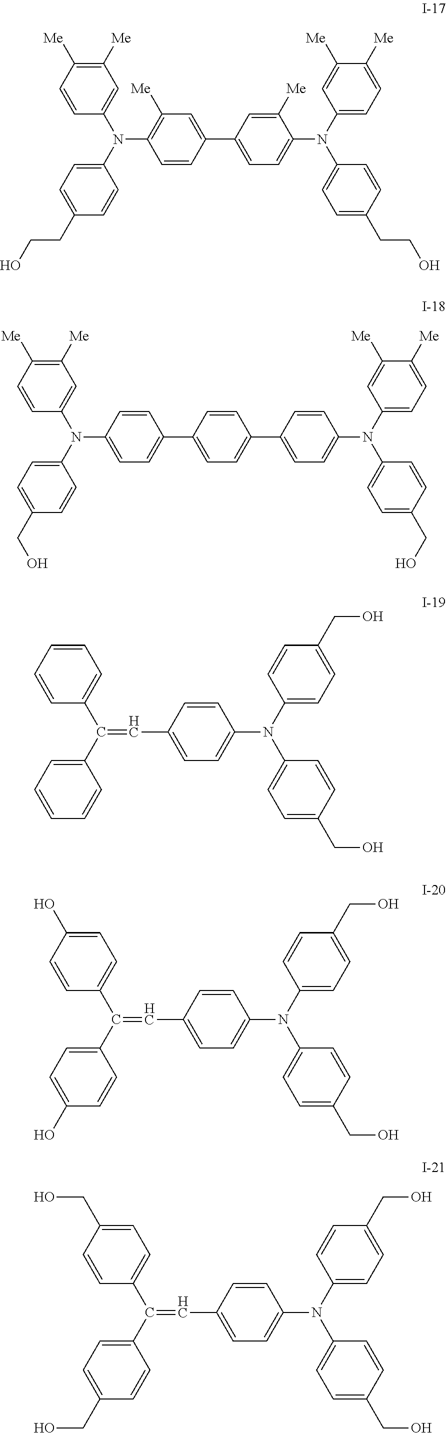

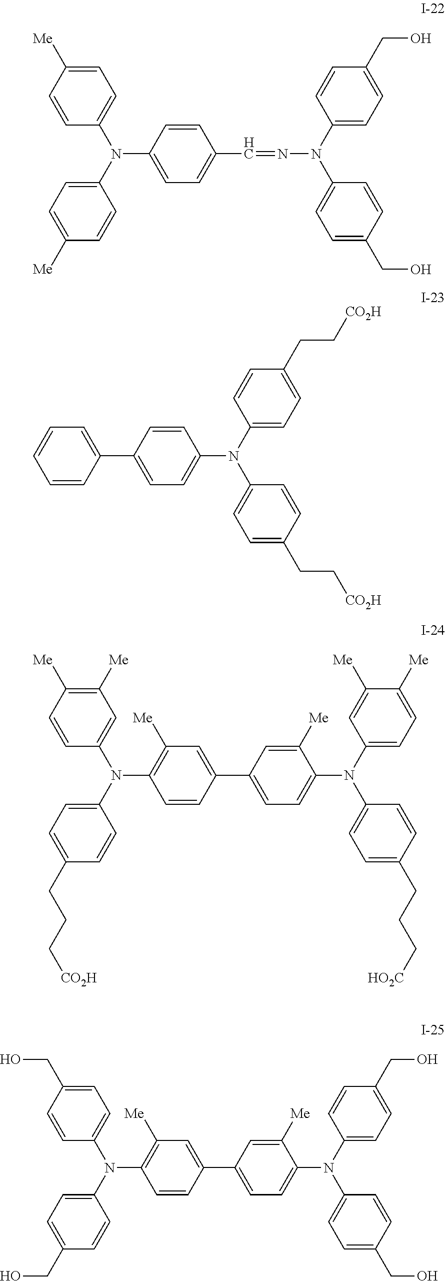

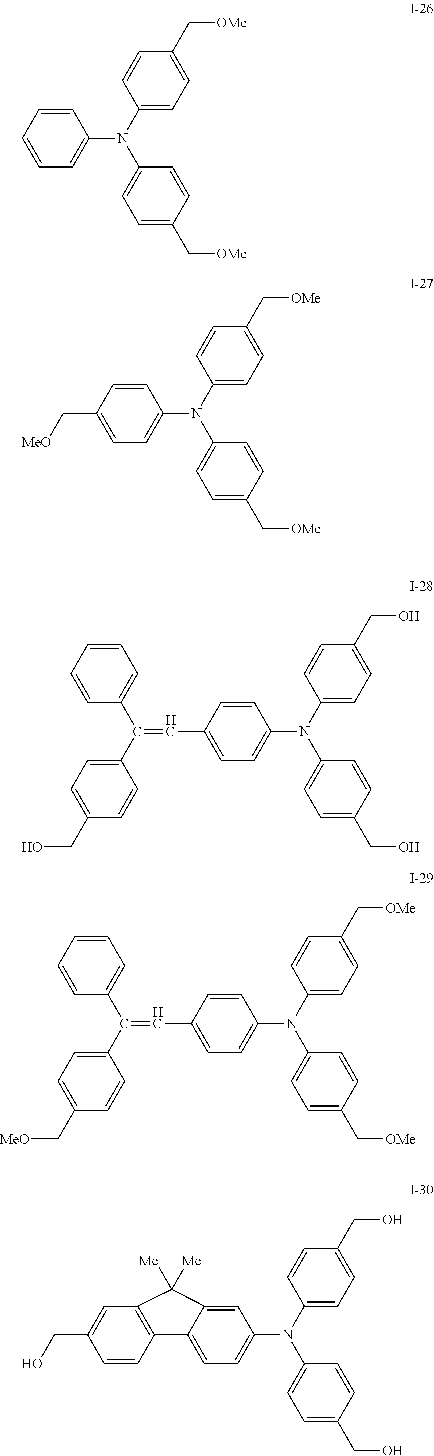

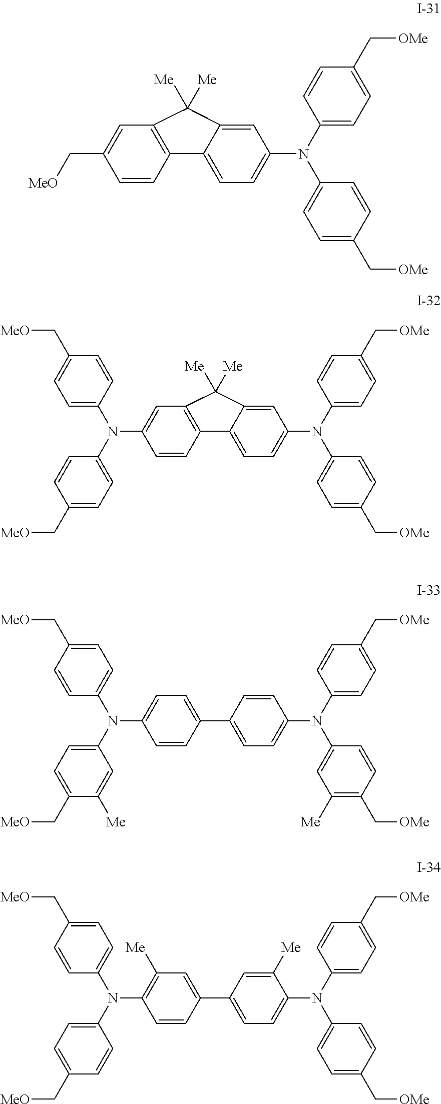

(B) Fluoro-Resin Particles

The protective layer 5 that is the overcoat layer of the electrophotographic photoreceptor of the first exemplary embodiment contains at least the (B) fluoro-resin particles.

The (B) fluoro-resin particles are not specifically limited. In embodiments, it may preferably include at least one of, or two or more of, tetrafluoroethylene resin (PTFE), chlorotrifluoroethylene resin, hexafluoro propylene resin, vinyl fluoride resin, vinylidene fluoride resin, diehlorodifluoroethylene resin, and copolymers thereof. Tetrafluoroethylene resin and vinylidene fluoride resin may be more preferable, and tetrafluoroethylene resin may be further preferable.

The average primary particle diameter of the fluoro-resin particles may be preferably from 0.05 μm to 1 μm and is more preferably from 0.1 μm to 0.5 μm.

The average primary particle diameter of the fluoro-resin particles herein refers to a value measured by a method including dispersing the fluoro-resin particles in the same solvent as that of the dispersion liquid containing the fluoro-resin particles dispersed therein to obtain a measurement liquid and subjecting the measurement liquid to measurement of the average primary particle diameter of the fluoro-resin particles at a refractive index of 1.35 using a laser diffraction type particle size distribution measuring device LA-700 (trade name, manufactured by Horiba, Ltd.).

The content of the (B) fluoro-resin particles with respect to the total solid content of the protective layer 5 that is the overcoat layer of the electrophotographic photoreceptor of the first exemplary embodiment may be preferably from 1% by mass to 30% by mass, and more preferably from 2% by mass to 20% by mass.

(C) Fluoro-Alkyl Group-Containing Copolymer

The protective layer 5 that is the overcoat layer of the electrophotographic photoreceptor of the first exemplary embodiment contains at least the (C) fluoro-alkyl group-containing copolymer.

The (C) fluoro-alkyl group-containing copolymer is not specifically limited. In embodiments, it may be preferably a fluoro graft polymer having a repeating unit represented by the following Structural Formula (1) and a repeating unit represented by the following Structural Formula (2), and more preferably a resin synthesized by graft polymerization or the like using a macromonomer formed from an acrylic acid ester, a methacrylic acid ester and/or the like and perfluoroalkylethyl(meth)acrylate and/or perfluoroalkyl(meth)acrylate. The expression of “(meth)acrylate” encompasses both of acrylate and methacrylate.

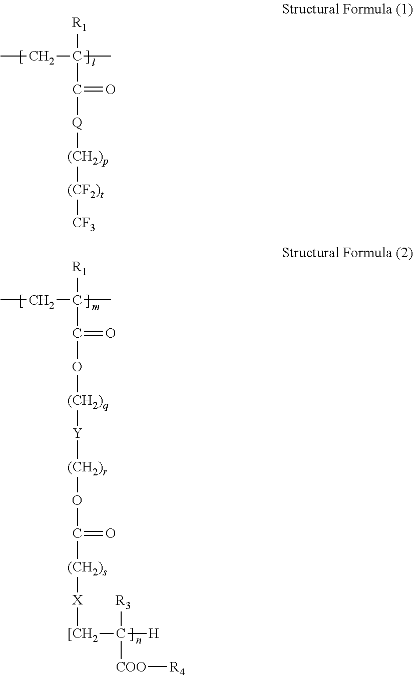

In Structural Formulae (1) and (2), 1, in and n each independently represent an integer equal to or larger than 1; p, q, r and s each independently represent 0 or an integer equal to or larger than 1; t represents an integer of 1 to 7; R₁, R₂, R₃ and R₄ each independently represent a hydrogen atom or an alkyl group; X represents an alkylene chain, a halogen-substituted alkylene chain, —S—, —O—, —NH— or a single bond; Y represents an alkylene chain, a halogen-substituted alkylene chain, —(C_{z}H_{2z-1}(OH))— or a single bond; z represents an integer equal to or larger than 1; and Q represents —O— or —NH—.

The weight-average molecular weight of the fluoro-alkyl group-containing copolymer may be preferably from 10,000 to 100,000, and more preferably from 30,000 to 100,000.

The ratio of the content of the repeating unit represented by Structural Formula (1) to that of repeating unit represented by Structural Formula (2) (namely, 1:m) may be preferably from 1:9 to 9:1, and may be more preferably from 3:7 to 7:3.

Examples of the alkyl group represented by R₁, R₂, R₃ or R₄ include a methyl group, an ethyl group, and a propyl group. In embodiments, R₁, R₂, R₃ and R₄ may preferably each independently represent a hydrogen atom or a methyl group, and further preferably each independently represent a methyl group.

The (C) fluoro-alkyl group-containing copolymer may further include a repeating unit represented by the following Structural Formula (3). The ratio of the sum of the content of the repeating unit represented by Structural Formula (1) and the content of the repeating unit represented by Structural Formula (2) to the content of the repeating unit represented by Structural Formula (3) (namely, 1+m:z) may be preferably from 10:0 to 7:3, and may be more preferably from 9:1 to 7:3.

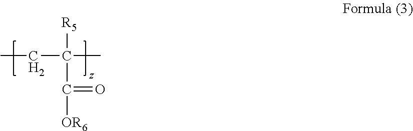

In Structural Formula (3), R₅ and R₆ each independently represent a hydrogen atom or an alkyl group, and z represents an integer equal to or larger than 1.

In embodiments, R₅ and R₆ may preferably each independently represent a hydrogen atom, a methyl group, or an ethyl group, and further preferably each independently represent a methyl group.

The content of the (C) fluoro-alkyl group-containing copolymer in the protective layer 5 that is the overcoat layer of the electrophotographic photoreceptor of the first exemplary embodiment may be preferably 1% by mass to 10% by mass with respect to the content of (B) the fluoro-resin particles in the protective layer 5.

(D) Other Component

The protective layer 5 may include, in combination with the cross-linked component formed from at least one selected from the guanamine compound or the melamine compound and the specific charge transporting material, other thermosetting resin such as a phenolic resin, a melamine resin, an urea resin, an alkyd resin, or a benzoguanamine resin. In embodiments, a compound having more functional groups in one molecule, such as a spiroacetal guanamine resin (for example, CTU-GUANAMINE (trade name, manufactured by Ajinomoto-Fine-Techno Co., Inc.)) may be copolymerized with the material to be incorporated in the cross-linked component.

The protective layer 5 may further include a surfactant in view of suppressing surface defects such as repellency. Examples of the surfactant include those having at least one of a fluorine atom, an alkylene oxide structure or a silicone structure.

The protective layer 5 may further include an antioxidant. Preferable examples of the antioxidants include hindered phenol antioxidants and hindered amine antioxidants, and known antioxidants such as organic sulfur antioxidant, phosphite antioxidants, dithiocarbamate antioxidants, thiourea antioxidants and benzimidazole antioxidants may also be used. The content of the antioxidant may be preferably 20% by mass or less, and more preferably 10% by mass or less.

Examples of the hindered phenol antioxidant include 2,6-di-t-butyl-4-methylphenol, 2,5-di-t-butylhydroquinone, N,N′-hexamethylene bis(3,5-di-t-butyl-4-hydroxyhydrocinnamide, 3,5-di-t-butyl-4-hydroxy-benzylphosphonate-diethylester, 2,4-bis[(octylthio)methyl]-o-cresol, 2,6-di-t-butyl-4-ethylphenol, 2,2′-methylenebis(4-methyl-6-t-butylphenol), 2,2′-methylenebis(4-ethyl-6-t-butylphenol), 4,4′-butylidenebis(3-methyl-6-t-butylphenol), 2,5-di-t-amylhydroquinone, 2-t-butyl-6-(3-butyl-2-hydroxy-5-methylbenzyl)-4-methylphenylacrylate, and 4,4′-butylidenebis(3-methyl-6-t-butylphenol).

The protective layer 5 may include a curing catalyst for accelerating curing of the guanamine compound, melamine compound and/or the charge transporting material. The curing catalyst may be preferably an acid catalyst. Examples of the acid catalyst include aliphatic carboxylic acids such as acetic acid, chloroacetic acid, trichloroacetic acid, trifluoroacetic acid, oxalic acid, maleic acid, malonic acid and lactic acid; aromatic carboxylic acids such as benzoic acid, phthalic acid, terephthalic acid and trimellitic acid; and aliphatic or aromatic sulfonic acids such as methanesulfonic acid, dodecylsulfonic acid, benzenesulfonic acid, dodecylbenzenesulfonic acid, and naphthalenesulfonic acid. Among these, sulfur-containing materials may be preferable.

The sulfur-containing material used as a curing catalyst may be preferably one that is acidic at normal temperature (for example, at 25° C.) or after heating, and may be more preferably at least one of organic sulfonic acids and derivatives thereof. The presence of the catalyst in the protective layer 5 may be readily detected by energy dispersive X-ray spectroscopy (EDS), X-ray photoelectron spectroscopy (XPS) or the like.

Examples of the organic sulfonic acids and/or the derivatives thereof include p-toluenesulfonic acid, dinonylnaphthalenesulfonic acid (DNNSA), dinonylnaphthalenedisulfonic acid (DNNDSA), dodecylbenzenesulfonic acid and phenolsulfonic acid. Among these, p-toluenesulfonic acid and dodecylbenzenesulfonic acid may be preferable. An organic sulfonic acid salt which is capable of dissociating in the curable resin composition may also be used.

A so-called heat latent catalyst that exhibits an increased degree of catalytic activity upon application of heat may also be used.

Examples of the heat latent catalyst include microcapsules formed by coating an organic sulfone compound or the like with a polymer in the form of particles; porous compounds such as zeolite to which an acid or the like is adsorbed; a heat latent protonic acid catalyst in which a protonic acid and/or a derivative thereof is blocked with a base; a compound obtained by esterifying a protonic acid and/or a derivative thereof with a primary or secondary alcohol; a compound obtained by blocking a protonic acid and/or a derivative thereof with a vinyl ether and/or a vinyl thioether; monoethyl amine complexes of boron trifluoride; and pyridine complexes of boron trifluoride.

Among these, the heat latent protonic acid catalyst in which a protonic acid and/or a derivative thereof is blocked with a base may be preferably used.

Examples of the protonic acid of the heat latent protonic acid catalyst include sulfuric acid, hydrochloric acid, acetic acid, formic acid, nitric acid, phosphoric acid, sulfonic acid, monocarboxylic acid, polycarboxylic acids, propionic acid, oxalic acid, benzoic acid, acrylic acid, methacrylic acid, itaconic acid, phthalic acid, maleic acid, benzene sulfonic acid, o-, m- or p-toluenesulfonic acid, styrenesulfonic acid, dinonylnaphthalenesulfonic acid, dinonylnaphthalenedisulfonic acid, decylbenzenesulfonic acid, undecylbenzenesulfonic acid, tridecylbenzenesulfonic acid, tetradecylbenzenesulfonic acid and dodecylbenzenesulfonic acid. Examples of the protonic acid derivative include neutralized alkali metal salts or alkali earth metal salts of protonic acids such as sulfonic acid and phosphoric acid, and polymer compounds in which a protonic acid skeleton is incorporated into a polymer chain (such as polyvinylsulfonic acid). Examples of the base that blocks the protonic acid include amines.

Amines are classified into primary, secondary, and tertiary amines. Any of these amines may be herein used without particular limitation.

Examples of the primary amines include methylamine, ethylamine, propylamine, isopropylamine, n-butylamine, isobutylamine, t-butylamine, hexylamine, 2-ethylhexylamine, secondary butylamine, allylamine and methylhexylamine.

Examples of the secondary amines include dimethylamine, diethylamine, di-n-propylamine, diisopropylamine, di-n-butylamine, diisobutylamine, di-t-butylamine, dihexylamine, di(2-ethylhexyl)amine, N-isopropyl-N-isobutylamine, di(2-ethylhexyl)amine, disecondarybutylamine, diallylamine, N-methylhexylamine, 3-pipecholine, 4-pipecholine, 2,4-lupetidine, 2,6-lupetidine, 3,5-lupetidine, morpholine, and N-methylbenzylamine.

Examples of the tertiary amines include trimethylamine, triethylamine, tri-n-propylamine, triisopropylamine, tri-n-butylamine, triisobutylamine, tri-t-butylamine, trihexylamine, tri(2-ethylhexyl)amine, N-methyl morpholine, N,N-dimethylallylamine, N-methyl diallylamine, triallylamine, N,N-dimethylallylamine, N,N,N,N′-tetramethyl-1,2-diaminoethane, N,N,N′,N′-tetramethyl-1,3-diaminopropane, N,N,N′,N′-tetraallyl-1,4-diaminobutane, N-methylpiperidine, pyridine, 4-ethylpyridine, N-propyldiallylamine, 3-dimethylaminopropanol, 2-ethylpyrazine, 2,3-dimethylpyrazine, 2,5-dimethylpyrazine, 2,4-lutidine, 2,5-lutidine, 3,4-lutidine, 3,5-lutidine, 2,4,6-collidine, 2-methyl-4-ethylpyridine, 2-methyl-5-ethylpyridine, N,N,N′,N′-tetramethylhexamethylenediamine, N-ethyl-3-hydroxypiperidine, 3-methyl-4-ethylpyridine, 3-ethyl-4-methylpyridine, 4-(5-nonyl)pyridine, imidazole and N-methylpiperazine.

Examples of commercially available products of the catalyst include NACURE 2501 (toluenesulfonic acid dissociation, methanol/isopropanol solvent, pH: 6.0 to 7.2, dissociation temperature: 80° C.), NACURE 2107 (p-toluenesulfonic acid dissociation, isopropanol solvent, pH: 8.0 to 9.0, dissociation temperature: 90° C.), NACURE 2500 (p-toluenesulfonic acid dissociation, isopropanol solvent, pH: 6.0 to 7.0, dissociation temperature: 65° C.), NACURE 2530 (p-toluenesulfonic acid dissociation, methanol/isopropanol solvent, pH: 5.7 to 6.5, dissociation temperature: 65° C.), NACURE 2547 (p-toluenesulfonic acid dissociation, aqueous solution, pH: 8.0 to 9.0, dissociation temperature: 107° C.), NACURE 2558 (p-toluene sulfonic acid dissociation, ethyleneglycol solvent, pH: 3.5 to 4.5, dissociation temperature: 80° C.), NACURE XP-357 (p-toluenesulfonic acid dissociation, methanol solvent, pH: 2.0 to 4.0, dissociation temperature: 65° C.), NACURE XP-386 (p-toluenesulfonic acid dissociation, aqueous solution, pH: 6.1 to 6.4, dissociation temperature: 80° C.), NACURE XC-2211 (p-toluenesulfonic acid dissociation, pH: 7.2 to 8.5, dissociation temperature: 80° C.), NACURE 5225 (dodecylbenzenesulfonic acid dissociation, isopropanol solvent, pH: 6.0 to 7.0, dissociation temperature: 120° C.), NACURE 5414 (dodecylbenzenesulfonic acid dissociation, xylene solvent, dissociation temperature: 120° C.), NACURE 5528 (dodecylbenzenesulfonic acid dissociation, isopropanol solvent, pH: 7.0 to 8.0, dissociation temperature: 120° C.), NACURE 5925 (dodecylbenzenesulfonic acid dissociation, pH: 7.0 to 7.5, dissociation temperature: 130° C.), NACURE 1323 (dinonylnaphthalenesulfonic acid dissociation, xylene solvent, pH: 6.8 to 7.5, dissociation temperature: 150° C.), NACURE 1419 (dinonylnaphthalenesulfonic acid dissociation, xylene/methylisobutylketone solvent, dissociation temperature: 150° C.), NACURE 1557 (dinonylnaphthalenesulfonic acid dissociation, butanol/2-butoxyethanol solvent, pH: 6.5 to 7.5, dissociation temperature: 150° C.), NACURE X49-110 (dinonylnaphthalenedisulfonic acid dissociation, isobutanol/isopropanol solvent, pH: 6.5 to 7.5, dissociation temperature: 90° C.), NACURE 3525 (dinonylnaphthalenedisulfonic acid dissociation, isobutanol/isopropanol solvent, pH: 7.0 to 8.5, dissociation temperature: 120° C.), NACURE XP-383 (dinonylnaphthalenedisulfonic acid dissociation, xylene solvent, dissociation temperature: 120° C.), NACURE 3327 (dinonylnaphthalenedisulfonic acid dissociation, isobutanol/isopropanol solvent, pH: 6.5 to 7.5, dissociation temperature: 150° C.), NACURE 4167 (phosphoric acid dissociation, isopropanol/isobutanol solvent, pH: 6.8 to 7.3, dissociation temperature: 80° C.), NACURE XP-297 (phosphoric acid dissociation, water/isopropanol solvent, pH: 6.5 to 7.5, dissociation temperature: 90° C.), and NACURE 4575 (phosphoric acid dissociation, pH: 7.0 to 8.0, dissociation temperature: 110° C.). The above-mentioned are all trade names of products manufactured by King Industries.

These heat latent catalysts may be used alone or in combination of two or more kinds thereof.

In embodiments, the ratio of the content of the catalyst to the total solid content of the overcoat layer excluding the content of the fluoro-resin particles and the content of the fluoro-alkyl group-containing copolymer may be preferably from approximately 0.1% by mass to approximately 10% by mass, and more preferably from approximately 0.1% by mass to approximately 5% by mass.

Formation of Protective layer

One exemplary embodiment of another aspect herein provided is a method of producing the photoreceptor according to the first aspect including forming the overcoat layer. In embodiments, an exemplary embodiment the method may include forming the protective layer 5, that is the overcoat layer in the first exemplary embodiment of the first aspect, as follows.

In embodiments, an exemplary embodiment the method of producing the photoreceptor of the first exemplary embodiment of the first aspect may include at least: preparing the substrate 1 having one or more layers, the one or more layers being other than the overcoat layer having the outermost surface (namely, preparing the substrate 1 having the undercoat layer 4, the charge-generating layer 2A, and the charge-transporting layer 2B, which are other than the protective layer 5); and forming the overcoat layer (protective layer 5) by applying a coating liquid on the substrate 1 and cross-linking components of the coating liquid applied on the substrate, the coating liquid containing at least one selected from a guanamine compound or a melamine compound and a charge-transporting material having at least one substituent group selected from —OH, —OCH₃, —NH₂, —SH, or —COOH (the specific charge-transporting material); fluoro-resin particles; a fluoro-alkyl group-containing copolymer; and a cyclic aliphatic ketone compound, and the coating liquid having: the ratio of the sum of the content of the guanamine compound and the content of the melamine compound to the total solid content of the coating liquid excluding the content of the fluoro-resin particles and the content of the fluoro-alkyl group-containing copolymer of from approximately 0.1% by mass to approximately 20% by mass; and the ratio of the content of the charge-transporting material to the total solid content of the coating liquid excluding the content of the fluoro-resin particles and the content of the fluoro-alkyl group-containing copolymer of from approximately 80% by mass to approximately 99.9% by mass.

In the embodiments of the method of producing the photoreceptor of the first exemplary embodiment of the first aspect, the coating liquid for forming the protective layer 5 having the structure explained above contains at least one of the guanamine compound or the melamine compound, at least one of the specific charge-transporting materials, the fluoro-resin particles, and the content of the fluoro-alkyl group-containing copolymer, details of which are explained above as the components of the protective layer 5.

A solvent in the coating liquid may be either one kind solvent or a mixture of two or more kinds of solvents. In embodiments, the solvent may preferably contain a cyclic aliphatic ketone compound. In embodiments, only one kind of the cyclic aliphatic ketone compound is used therefor.

The use of the cyclic aliphatic ketone compound may facilitate to have the fluoro-resin particles that are contained in the protective layer 5 serving as the overcoat layer expose on the outermost surface, so that the surface energy lowers and that a property of excellent cleaning ability may be exerted immediately after beginning of use of the photoreceptor.

In embodiments, the solvent used for forming the protective layer 5 as the overcoat layer may be preferably the cyclic aliphatic ketone compound such as cyclobutanone, cyclopentanone, cyclohexanone or cycloheptanone as described above. In embodiments, another solvent may be used in combination with the cyclic aliphatic ketone compound, examples thereof including cyclic- or straight-chain-alcohols such as methanol, ethanol, propanol, butanol, and cyclopentanol; straight-chain-ketones such as acetone and methyl ethyl ketone; straight-chain-ethers such as tetrahydrofuran, dioxane, ethylene glycol and diethyl ether; and haloganated aliphatic hydrocarbon solvents such as methylene chloride, chloroform, and ethylene chloride.

In embodiments, the cyclic aliphatic ketone compound may be preferably that having a ring including 4 to 7 carbon atoms, and may be more preferably that having a ring including 5 or 6 carbon atoms.

The content of the solvent used for forming the protective layer 5 is not particularly limited. In embodiments, it may be from 0.5% by mass to 30% by mass, and may be preferably from 1% by mass to 20% by mass, with respective to 1% by mass of the guanamine compound or the melamine compound.

Examples of a method for applying the coating liquid for forming the protective layer as the overcoat layer include thrust up coating, ring coating, blade coating, Mayer bar coating, spray coating, dip coating, bead coating, air knife coating, curtain coating, and inkjet coating. After the application, the coating liquid may be subjected to curing (cross-linking) by heating at a temperature of, for example, from 100° C. to 170° C., to provide the protective layer 5.

Second Exemplary Embodiment of Photoreceptor (Exemplary Embodiment in which the Overcoat Layer is a Charge-Transporting Layer)

A photoreceptor according to the second exemplary embodiment of the first aspect has, as shown in FIG. 2, the undercoat layer 4, the charge-generating layer 2A, and the charge-transporting layer 2B which are stacked on the substrate 1 in this order to form a layer configuration, and the charge-transporting layer 2B serves as the overcoat layer.

Details of the substrate 1, the undercoat layer 4, and the charge-generating layer 2A in the second exemplary embodiment are similar to those of the first exemplary embodiment as shown in FIG. 1.

Charge-Transporting Layer

The charge-transporting layer 2B, that serves as the overcoat layer in the photoreceptor according to the second exemplary embodiment of the first aspect, includes at least:

(A) the cross-linked component that is obtained by cross-linking of at least one selected from a guanamine compound or a melamine compound and a charge-transporting material having at least one substituent group selected from —OH, —OCH₃, —NH₂, —SH, or —COOH (the specific charge-transporting material);

(B) fluoro-resin particles;

(C) a fluoro-alkyl group-containing copolymer; and

(D) optional other component,

and the ratio of fluorine atom present in the outermost surface of the overcoat layer as measured with energy dispersive X-ray analysis (EDS) is from approximately 1.0% by mass to approximately 20.0% by mass.

The components (A) to (C) that are described as those for the protective layer 5 in the first exemplary embodiment of the first aspect may be used as the component (A) to (C) in the charge-transporting layer 2B of this exemplary embodiment as they are. Examples of the component (D) that may be contained in the charge-transporting layer 2B include, besides the component (D) that is described in the protective layer 5 in the first exemplary embodiment, various kinds of compositions that may be contained in the charge-transporting layer 2B in the first exemplary embodiment.

The charge-transporting layer 2B that serves as the overcoat layer in the second exemplary embodiment may be preferably formed in accordance with the method of forming the protective layer 5 that serves as the overcoat layer in the exemplary embodiment.

In embodiments, the method of producing the photoreceptor of the second exemplary embodiment of the first aspect may include at least: preparing the substrate 1 having one or more layers, the one or more layers being other than the overcoat layer having the outermost surface (namely, preparing the substrate 1 having the undercoat layer 4, the charge-generating layer 2A, and the like, which are other than the charge-transporting layer 2B); and forming the overcoat layer (charge-transporting layer 2B) by applying a coating liquid on the substrate 1 and cross-linking components of the coating liquid applied on the substrate, the coating liquid containing at least one selected from a guanamine compound or a melamine compound and a charge-transporting material having at least one substituent group selected from —OH, —OCH₃, —NH₂, —SH, or —COOH (the specific charge-transporting material); fluoro-resin particles; a fluoro-alkyl group-containing copolymer; and a cyclic aliphatic ketone compound, and the coating liquid having: the ratio of the sum of the content of the guanamine compound and the content of the melamine compound to the total solid content of the coating liquid excluding the content of the fluoro-resin particles and the content of the fluoro-alkyl group-containing copolymer of from approximately 0.1% by mass to approximately 20% by mass; and the ratio of the content of the charge-transporting material to the total solid content of the coating liquid excluding the content of the fluoro-resin particles and the content of the fluoro-alkyl group-containing copolymer of from approximately 80% by mass to approximately 99.9% by mass.

Regarding the cyclic aliphatic ketone compound or the other solvent that is used to form the charge-transporting layer 2B in the second exemplary embodiment, the used amount of these solvents, the coating method of the coating liquid, and others are similar to those described in the method of forming the protective layer in the first exemplary embodiment.

Third Exemplary Embodiment of Photoreceptor (Exemplary Embodiment in which the Overcoat Layer is a Function-Hybridized Photosensitive Layer)

A photoreceptor according to the third exemplary embodiment of the first aspect has, as shown in FIG. 3, the undercoat layer 4 and the function-hybridized photosensitive layer 6 which are stacked on the substrate 1 in this order to form a layer configuration, and the function-hybridized photosensitive layer 6 serves as the overcoat layer.

Details of the substrate 1 and the undercoat layer 4 in the second exemplary embodiment are similar to those in the first exemplary embodiment as shown in FIG. 1.

Function-Hybridized Photosensitive Layer

The function-hybridized photosensitive layer 6, that serves as the overcoat layer in the photoreceptor according to the third exemplary embodiment of the first aspect, includes at least:

(A) the cross-linked component that is obtained by cross-linking of at least one selected from a guanamine compound or a melamine compound and a charge-transporting material having at least one substituent group selected from —OH, —OCH₃, —NH₂, —SH, or —COOH (the specific charge-transporting material);

(B) fluoro-resin particles;

(C) a fluoro-alkyl group-containing copolymer; and

(D) optional other component,

and the ratio of fluorine atom present in the outermost surface of the overcoat layer as measured with energy dispersive X-ray analysis (EDS) is from approximately 1.0% by mass to approximately 20.0% by mass.

The components (A) to (C) that are described as those for the protective layer 5 in the first exemplary embodiment of the first aspect may be used as the component (A) to (C) in the function-hybridized photosensitive layer 6 of this exemplary embodiment as they are. Examples of the component (D) that may be contained in the function-hybridized photosensitive layer 6 include, besides the component (D) that is described in the protective layer 5 in the first exemplary embodiment, various kinds of compositions that may be contained in the charge-generating layer 2A or the charge-transporting layer 2B in the first exemplary embodiment.

The function-hybridized photosensitive layer 6 that serves as the overcoat layer in the third exemplary embodiment may be preferably formed in accordance with the method of forming the protective layer 5 that serves as the overcoat layer in the exemplary embodiment.

In embodiments, the method of producing the photoreceptor of the third exemplary embodiment of the first aspect may include at least: preparing the substrate 1 having one or more layers, the one or more layers being other than the overcoat layer having the outermost surface (namely, preparing the substrate 1 having the undercoat layer 4 and the like, which are other than the function-hybridized photosensitive layer 6); and forming the overcoat layer (function-hybridized photosensitive layer 6) by applying a coating liquid on the substrate 1 and cross-linking components of the coating liquid applied on the substrate, the coating liquid containing at least one selected from a guanamine compound or a melamine compound and a charge-transporting material having at least one substituent group selected from —OH, —OCH₃, —NH₂, —SH, or —COOH (the specific charge-transporting material); fluoro-resin particles; a fluoro-alkyl group-containing copolymer; and a cyclic aliphatic ketone compound, and the coating liquid having: the ratio of the sum of the content of the guanamine compound and the content of the melamine compound to the total solid content of the coating liquid excluding the content of the fluoro-resin particles and the content of the fluoro-alkyl group-containing copolymer of from approximately 0.1% by mass to approximately 20% by mass; and the ratio of the content of the charge-transporting material to the total solid content of the coating liquid excluding the content of the fluoro-resin particles and the content of the fluoro-alkyl group-containing copolymer of from approximately 80% by mass to approximately 99.9% by mass.

Regarding the cyclic aliphatic ketone compound or the other solvent that is used to form the function-hybridized photosensitive layer 6 in the third exemplary embodiment, the used amount of these solvents, the coating method of the coating liquid, and others are similar to those described in the method of forming the protective layer in the first exemplary embodiment.

Process Cartridge and Image Forming Apparatus

A process cartridge according to an exemplary embodiment of another aspect herein provided is not particularly limited as long as one exemplary embodiment of the electrophotographic photoreceptor of the first aspect is used therein. In embodiments, the process cartridge may be preferably composed of the electrophotographic photoreceptor that serves as a latent image support and at least one selected from a charging unit, a development unit, or a cleaning unit, and freely attachable to and detachable from an image forming apparatus that transfers a toner image obtained by developing an electrostatic image on the surface of the latent image support onto a recording medium and forms an image on the recording medium.

An image forming apparatus according to an exemplary embodiment of another aspect herein provided is not particularly limited as long as one exemplary embodiment of the electrophotographic photoreceptor of the first aspect is used therein. In embodiments, the image forming apparatus may be preferably composed of the electrophotographic photoreceptor, a charging unit that charges the electrophotographic photoreceptor, a latent image forming unit that forms an electrostatic latent image on a surface of the electrophotographic photoreceptor, a development unit that develops the electrostatic latent image formed on the surface of the electrophotographic photoreceptor with a toner and forms a toner image, and a transferring unit that transfers the toner image formed on the surface of the electrophotographic photoreceptor onto a recording medium. In embodiments, the image forming apparatus according to the exemplary embodiment may be a so-called tandem machine that possesses two or more photoreceptors corresponding to each of color toners. In this case, all of the photoreceptors may be preferably the electrophotographic photoreceptor. Further, the toner image may be transferred in an intermediate transfer system in which an intermediate transfer member is used.

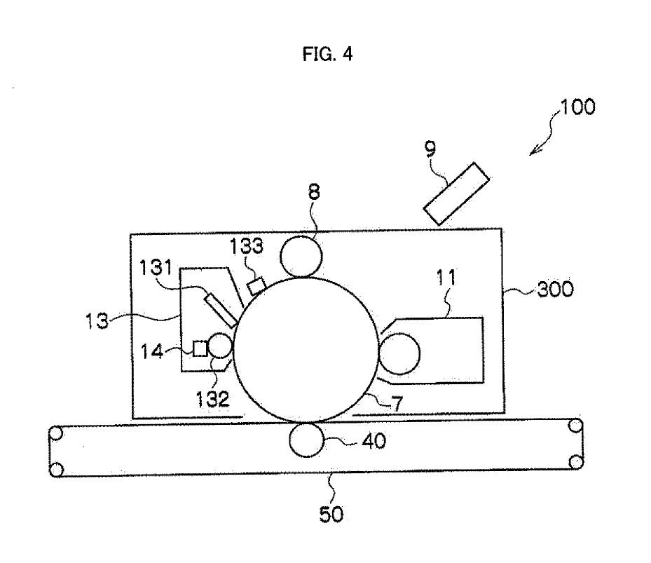

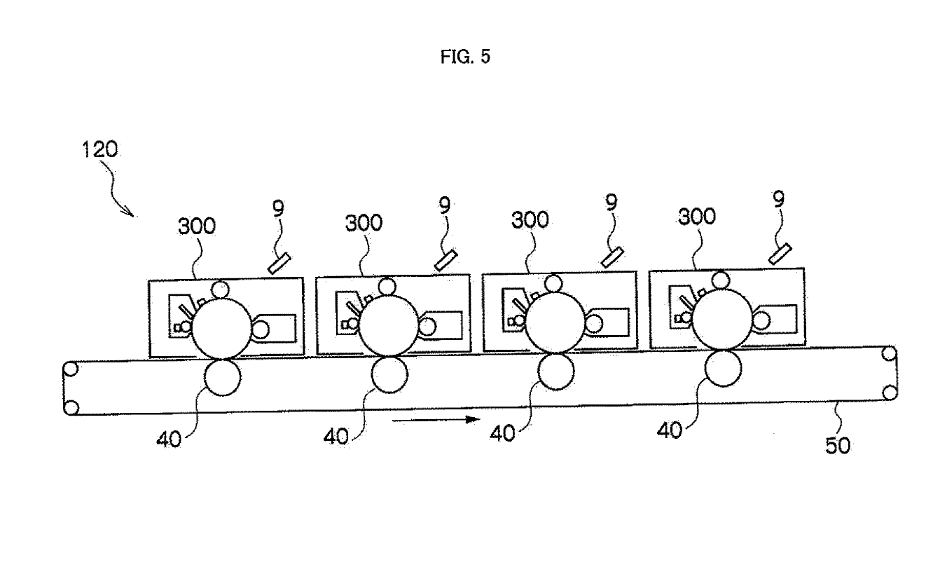

FIG. 4 is a schematic view showing an image forming apparatus according to an exemplary embodiment of one aspect of the invention. As shown in FIG. 4, the image forming apparatus 100 includes a process cartridge 300 equipped with an electrophotographic photoreceptor 7, an exposure device 9, a transfer device 40, and an intermediate transfer member 50. In the image forming apparatus 100, the exposure device 9 is positioned such that the electrophotographic photoreceptor 7 is exposed to light through an opening of the process cartridge 300, the transfer device 40 is positioned opposite to the electrophotographic photoreceptor 7 via the intermediate transfer member 50, and the intermediate transfer member 50 is positioned so as to be partially in contact with the electrophotographic photoreceptor 7.

The process cartridge 300 integrally includes the electrophotographic photoreceptor 7, the charging device 8, a developing device 11 and a cleaning device 13 in a housing. The cleaning device 13 has a cleaning blade 131 (cleaning member). The cleaning blade 131 is positioned so as to be in contact with the surface of the electrophotographic photoreceptor 7.

A fibrous member 132 (roll-shaped) that supplies a lubricant 14 to the surface of the electrophotographic photoreceptor 7 and a fibrous member 133 that assists cleaning (flat brush-shaped) are used in this exemplary embodiment, although these may be provided or may not be provided in this system.

As the charging device 8, for example, a contact-type charging device employing a conductive or semiconductive charging roller, a charging brush, a charging film, a charging rubber blade, a charging tube, or the like may be used. Known non contact-type charging devices such as a non contact-type roller charging device, scorotron or corotron charging devices utilizing corona discharge, or the like, may also be used.

Although not shown in the drawings, a heating member may be provided around the electrophotographic photoreceptor 7 in order to increase the temperature of the electrophotographic photoreceptor 7 to reduce the relative temperature thereof.

Examples of the exposure device 9 include optical instruments which expose the surface of the electrophotographic photoreceptor 7 to light of a semiconductor laser, an LED, a liquid-crystal shutter light or the like in a pattern of desired image. The wavelength of the light source to be used is in the range of the spectral sensitivity region of the electrophotographic photoreceptor. As the semiconductor laser light, near-infrared light having an oscillation wavelength in the vicinity of 780 nm is mainly used. However, the wavelength of the light source is not limited to the above range, and lasers having an oscillation wavelength on the order of 600 nm and blue lasers having an oscillation wavelength in the vicinity of 400 nm to 450 nm may also be used. Surface-emitting type laser light sources which are capable of multi-beam output may be also effective in forming a color image.

As the developing device 11, for example, a common developing device that performs development by contacting or non-contacting a magnetic or non-magnetic one- or two-component developer may be used. Such developing device is not particularly limited as long as it has above-described functions, and may be appropriately selected according to the preferred use. Examples thereof include known developing device that performs development by attaching one- or two-component developer to the electrophotographic photoreceptor 7 using a brush or a roller.

A toner to be used in the developing device 11 will be described below.

The toner particles used in the image forming apparatus of this exemplary embodiment may preferably have an average shape factor (ML²/A×π/4×100, wherein ML represents a maximum length of a particle and A represents a projection area of the particle.) of 100 to 150, more preferably 105 to 145, and further preferably 110 to 140. The volume-average particle diameter of the toner particles may be preferably 3 μm to 12 μm, and more preferably from 3.5 μm to 9 μm.

The method of producing the toner is not particularly limited. Examples of the method include a kneading and pulverizing method in which a binder resin, a coloring agent, a releasing agent, and optionally a charge control agent or the like are mixed and kneaded, pulverized, and classified; a method of altering the shape of the particles obtained by the kneading and pulverizing method using mechanical shock or heat energy; an emulsion polymerization aggregation method in which a dispersion obtained by emulsifying and polymerizing a polymerizable monomer of a binder resin is mixed with a dispersion containing a coloring agent, a releasing agent, and optionally a charge control agent and/or other agents, then the mixture is subjected to aggregation, heating and coalescing to obtain toner particles; a suspension polymerization method in which a polymerizable monomer used to obtain a binder resin and a solution containing a coloring agent, a releasing agent and optionally a charge control agent and/or other agents are suspended in an aqueous medium and subjecting the suspension to polymerization; and a dissolution-suspension method in which a binder resin and a solution containing a coloring agent, a releasing agent and optionally a charge control agent and/or other agents are suspended in an aqueous medium to form particles.

Known methods such as a method of producing toner particles having a core-shell structure in which aggregated particles are further attached to a core formed from the toner particles obtained by the above-described method, then heated and coalesced may also be used. As the method of producing toner particles, methods of producing a toner in an aqueous medium such as a suspension-polymerization method, an emulsion polymerization aggregation method, and a dissolution suspension method may be preferable, and an emulsion polymerization aggregation method may be further preferable from the viewpoint of controlling the shape and particle diameter distribution of the toner particles.

Toner mother particles may be preferably formed from a binder resin, a coloring agent and a releasing agent, and may optionally contain silica and/or a charge control agent.

Examples of the binder resins used in the toner mother particles include monopolymers and copolymers of styrenes such as styrene and chlorostyrene, monoolefins such as ethylene, propylene, butylene and isoprene, vinyl esters such as vinyl acetate, vinyl propionate, vinyl benzoate, vinyl butyrate, α-methylene aliphatic monocarboxylic acid esters such as methyl acrylate, ethyl acrylate, butyl acrylate, dodecyl acrylate, octyl acrylate, phenyl acrylate, methyl methacrylate, ethyl methacrylate, butyl methacrylate and dodecyl methacrylate, vinyl ethers such as vinyl methyl ether, vinyl ethyl ether and vinyl butyl ether, and vinyl ketones such as vinyl methyl ketone, vinyl hexyl ketone and vinyl isopropenyl ketone, and polyester resins synthesized by copolymerizing a dicarboxylic acid and a diol.

Examples of the typical binder resins include polystyrene, styrene-alkyl acrylate copolymer, styrene-alkyl methacrylate copolymer, styrene-acrylonitrile copolymer, styrene-butadiene copolymer, styrene-maleic anhydride copolymer, polyethylene, polypropylene and polyester resins. Other examples include polyurethane, epoxy resins, silicone resins, polyamide, modified rosin and paraffin wax.

Examples of the typical coloring agents include magnetic powder such as magnetite and ferrite, carbon black, aniline blue, Calco Oil blue, chrome yellow, ultramarine blue, Du Pont oil red, quinoline yellow, methylene blue chloride, phthalocyanine blue, malachite green oxalate, lamp black, rose bengal, C. I. Pigment Red 48:1, C. I. Pigment Red 122, C. I. Pigment Red 57:1, C. I. Pigment Yellow 97, C. I. Pigment Yellow 17, C. I. Pigment Blue 15:1, and C. I. Pigment Blue 15:3.

Examples of the typical releasing agents include low-molecular polyethylene, low-molecular polypropylene, Fischer-Tropsch wax, montan wax, carnauba wax, rice wax and candelilla wax.

Known agents such as azo metal-complex compounds, metal-complex compounds of salicylic acid, and resin-type charge control agents having polar groups can be used as the charge control agent. When toner particles are produced by a wet method, materials that do not readily dissolve in water may be preferably used. The toner may be either a magnetic toner which contains a magnetic material or a non-magnetic toner which contains no magnetic material.

The toner particles used in the developing device 11 may be produced by mixing the toner mother particles and external additives using a Henschel mixer, a V blender or the like. In the case in which the toner mother particles are produced by a wet process, external additives may be added by a wet method.

Lubricant particles may be added to the toner used in the developing device 11. Examples of the lubricant particles include solid lubricants such as graphite, molybdenum disulfide, talc, fatty acids and metal salts of fatty acids, low molecular weight polyolefins such as polypropylene, polyethylene and polybutene, silicones having a softening point by heating, fatty-acid amides such as oleic acid amide, erucic acid amide, ricinoleic acid amide and stearic acid amide, vegetable waxes such as carnauba wax, rice wax, candelilla wax, Japan wax and jojoba oil, animal waxes such as beeswax, mineral and petroleum waxes such as montan wax, ozokerite, ceresine, paraffin wax, microcrystalline wax and Fischer-Tropsch wax, and modified products thereof. These may be used alone or in combination of two or more kinds thereof. The average particle diameter of the lubricant particles may be preferably in the range of from 0.1 μm to 10 μm, and those having the above-described chemical structure may be ground to form particles having such particle diameter. The content of the particles in the toner may be preferably in the range of from 0.05% by mass to 2.0% by mass, more preferably 0.1% by mass to 1.5% by mass.

Inorganic particles, organic particles, composite particles in which inorganic particles are attached to organic particles, or the like may be added to the toner particles used in the developing device 11.

Examples of the appropriate inorganic particles include various inorganic oxides, inorganic nitrides and inorganic borides such as silica, alumina, titania, zirconia, barium titanate, aluminum titanate, strontium titanate, magnesium titanate, zinc oxide, chromium oxide, cerium oxide, antimony oxide, tungsten oxide, tin oxide, tellurium oxide, manganese oxide, boron oxide, silicon carbide, boron carbide, titanium carbide, silicon nitride, titanium nitride and boron nitride.

The above-described inorganic particles may be treated with a titanium coupling agent or a silane coupling agent. Examples of the titanium coupling agents include tetrabutyl titanate, tetraoctyl titanate, isopropyltriisostearoyl titanate, isopropyltridecylbenzenesulfonyl titanate and bis(dioctylpyrophosphate)oxyacetate titanate. Examples of the silane coupling agents include γ-(2-aminoethyl)aminopropyltrimethoxysilane, γ-(2-aminoethypaminopropylmethyldimethoxysilane, γ-methacryloxypropyltrimethoxysilane, N-β-(N-vinylbenzylaminoethyl)γ-aminopropyltrimethoxysilane hydrochloride, hexamethyldisilazane, methyltrimethoxysilane, butyltrimethoxysilane, isobutyltrimethoxysilane, hexyltrimethoxysilane, octyltrimethoxysilane, decyltrimethoxysilane, dodecyltrimethoxysilane, phenyltrimethoxysilane, o-methylphenyltrimethoxysilane and p-methylphenyltrimethoxysilane.

These inorganic particles may be subjected to a hydrophobic treatment with silicone oil or a metal salt of higher fatty acids such stearic acid aluminum, stearic acid zinc and stearic acid calcium.

Examples of the organic particles include styrene resin particles, styrene acrylic resin particles, polyester resin particles and urethane resin particles.

The number average particle diameter of these particles may be preferably from 5 nm to 1000 nm, more preferably from 5 nm to 800 nm, and further preferably from 5 nm to 700 nm. The sum of the content of these particles and the content of the lubricant particles may be preferably 0.6% by mass or more.

A combination of small inorganic oxide particles having a primary diameter of 40 nm or less and inorganic oxide particles having a larger primary average diameter than the small inorganic oxide particles may be preferably used as the other inorganic oxides to be added to the toner particles. These inorganic oxide particles may be formed from a known material, and in embodiments, a combination of silica particles and titanium oxide particles may be preferable.

The small inorganic particles may be subjected to a surface treatment. Addition of a carbonate such as calcium carbonate or magnesium carbonate or an inorganic mineral such as hydrotalcite may be also preferable.

Color toner particles for electrophotography are used in combination with carriers. Examples of the carrier include iron powder, glass beads, ferrite powder, nickel powder and these powders coated with a resin. The mixing ratio of the carrier may be determined in accordance with necessity.

Examples of the transfer device 40 include known transfer charging devices such as a contact type transfer charging devices using a belt, a roll, a film or a rubber blade, and that utilizing corona discharge such as a scorotron transfer charging device or a corotron transfer charging device.

As the intermediate transfer member 50, a belt to which semiconductivity is imparted and made of polyimide, polyamideimide, polycarbonate, polyarylate, polyester, rubber or the like (intermediate transfer belt) may be used. The intermediate transfer member 50 may also be in the form of a drum.

In addition to the above-described devices, the image forming apparatus 100 may further have, for example, a photodischarge device for charge-erasing the electrophotographic photoreceptor 7.

FIG. 5 is a schematic cross-sectional view showing an image forming apparatus 120 according to another exemplary embodiment. As shown in FIG. 5, the image forming apparatus 120 is a tandem-type full-color image forming apparatus including four process cartridges 300. In the image forming apparatus 120, four process cartridges 300 are disposed in parallel with each other on the intermediate transfer member 50, and one electrophotographic photoreceptor is used for each color. The image forming apparatus 120 has a similar configuration to the image forming apparatus 100, except that the apparatus is a tandem type.

In the image forming apparatus (process cartridge) according to this exemplary embodiment, the development apparatus (development unit) may include a development roll as a developer retainer which moves (rotates) in a direction opposite to the direction (rotation direction) in which the electrophotographic photoreceptor moves. For example, the development roll has a cylindrical development sleeve for retaining the developer on the surface thereof, and the development apparatus may have a regulation member that regulates the amount of the developer to be supplied to the development sleeve. When the development roll of the development apparatus is moved (rotated) in a direction opposite to the rotation direction of the electrophotographic photoreceptor, the surface of the electrophotographic photoreceptor is rubbed with the toner remaining between the development roll and the electrophotographic photoreceptor.

In the image forming apparatus (process cartridge) according to this exemplary embodiment, the space between the development sleeve and the electrophotographic photoreceptor may be preferably from 200 μm to 600 μm, and more preferably from 300 μm to 500 μm. The space between the development sleeve and the regulation blade, which is a regulation member that regulates the amount of the developer, may be preferably from 300 μm to 1000 μm, and more preferably from 400 μm to 750 μm.

An absolute value of moving velocity of the development roll surface (process speed) may be preferably from 1.5 times to 2.5 times, more preferably from 1.7 times to 2.0 times, as large as an absolute value of the moving velocity of the electrophotographic photoreceptor surface.

In the image forming apparatus (process cartridge) according to this exemplary embodiment, the development apparatus (development unit) may preferably include a developer retainer having a magnetic substance, and develops an electrostatic latent image with a two-component developer containing a magnetic carrier and a toner.

### EXAMPLES

The invention is further illustrated in reference to following Examples. However, the invention is not limited to the Examples.

### Example 1

An electrophotographic photoreceptor is prepared in accordance with the following process.

Preparation of Undercoat Layer

100 parts by mass of zinc oxide (average particle diameter: 70 nm, manufactured by Tayca Corporation, specific surface area: 15 m²/g) is mixed with 500 parts by mass of toluene by stirring, and 1.3 parts by mass of a silane coupling agent (trade name: KBM503, manufactured by Shin-Etsu Chemical Co., Ltd.) is added thereto and stirred for 2 hours. Subsequently, toluene is distilled away under reduced pressure, and baking is carried out at a temperature of 120° C. for 3 hours, thereby obtaining zinc oxide with the surface treated with a silane coupling agent.

60 parts by mass of the surface-treated zinc oxide is mixed with 0.6 parts by mass of alizarin, 13.5 parts by mass of a curing agent (blocked isocyanate, trade name: SUMIDUR 3175, manufactured by Sumitomo-Bayer Urethane Co., Ltd.), 38 parts by mass of a solution prepared by dissolving 15 parts by mass of a butyral resin (trade name: S-LEC BM-1, manufactured by Sekisui Chemical Co., Ltd.) in 85 parts by mass of methyl ethyl ketone, and 25 parts by mass of methyl ethyl ketone are mixed and dispersed for 2 hours in a sand mill using glass beads having a diameter of 1 mm, thereby obtaining a dispersion.

To the obtained dispersion are added 0.005 parts by mass of dioctyltin dilaurate as a catalyst and 40 parts by mass of silicone resin particles (trade name: TOSPAL 145, manufactured by Momentive Performance Materials Inc.), thereby obtaining a coating liquid for forming an undercoat layer. An undercoat layer having a thickness of 19 μm is formed by applying the obtained coating liquid onto an aluminum substrate having a diameter of 30 mm by dip coating, and then drying to cure at a temperature of 170° C. for 40 minutes.

Preparation of Charge Generating Layer

A mixture of 15 parts by mass of hydroxygalliumphthalocyanine having diffraction peaks at least at 7.3°, 16.0°, 24.9° and 28.0° of Bragg angles (2θ±0.2°) in an X-ray diffraction spectrum obtained by using Cukα X rays as a charge generating material, 10 parts by mass of vinyl chloride-vinyl acetate copolymer resin (trade name: VMCH, manufactured by Nippon Unicar Co., Ltd.) as a binder resin, and 200 parts by mass of n-butyl acetate is dispersed for 4 hours in a sand mill using glass beads with a diameter of 1 mm. To the obtained dispersion are added 175 parts by mass of n-butyl acetate and 180 parts by mass of methyl ethyl ketone and stirred, thereby obtaining a coating liquid for forming a charge generating layer. The coating liquid for forming a charge generating layer is applied onto the undercoat layer by dip coating, and dried at an ordinary temperature (25° C.) to form a charge generating layer having a film thickness of 0.2 μm.

Preparation of Charge Transport Layer

45 parts by mass of N,N′-diphenyl-N,N′-bis(3-methylphenyl)-[1,1]biphenyl-4,4′-diamine and 55 parts by mass of bisphenol Z polycarbonate resin (viscosity average molecular weight: 50,000) are dissolved in 800 parts by mass of chlorobenzene to obtain a coating liquid for forming a charge transport layer. The coating liquid is applied onto the charge generating layer, and then dried at a temperature of 130° C. for 45 minutes to form a charge transport layer having a film thickness of 20 μm.

Preparation of Protective Layer

5 parts by mass of “LUBRON L-2” (trade name, manufactured by DAIKIN INDUSTRIES, Ltd., tetrafluoroethylene resin particles) and 0.25 parts by mass of a fluoro-alkyl group-containing copolymer that contains the repeating units represented by the following Structural Formula (4) (50,000 of weight average molecular weight, 1:m=1:1, s=1, n=60) are sufficiently mixed with 17 parts by mass of cyclopentanone (cyclic aliphatic ketone compound) and agitated to prepare a suspension liquid of tetrafluoroethylene resin particles.

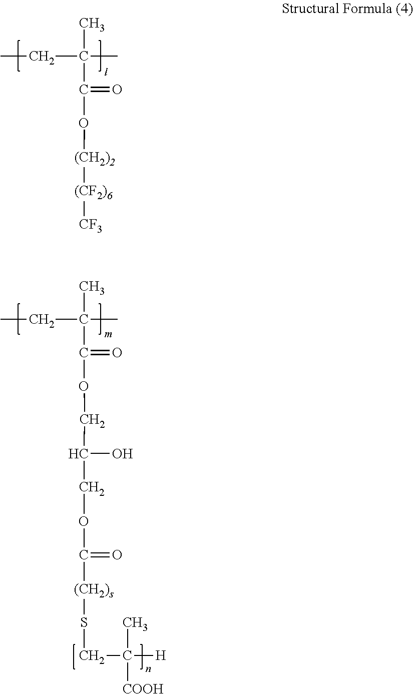

Then, 5 parts by mass of a melamine resin and 95 parts by mass of the compound I-16 shown above as a charge-transporting material are added to 220 parts by mass of cyclopentanone; after these are sufficiently dissolved and mixed, the suspension liquid of tetrafluoroethylene resin particles is added thereto. After agitation and mixing, the resulting mixture is subjected to a dispersing treatment with a high pressure homogenizer (trade name: YSNM-1500AR, manufactured by Yoshida Kikai Co., Ltd.) equipped with a feed-through chamber having fine flow channels at an elevated pressure of 700 kgf/cm² repeatedly 20 times. After that, 0.2 parts by mass of “NACURE 5225” (trade name, manufactured by King Industries, Inc.) that serves as a catalyst is added to the mixture so as to prepare a coating liquid for forming a protective layer. The coating liquid is coated on the charge-transporting layer by using the thrust up coating technique and is cured by heating at 150° C. for 1 hour so as to obtain a thick protective layer having a thickness of 4 μm. In this way, an electrophotographic photoreceptor for Example 1 is prepared.

An electrophotographic photoreceptor used in “DOCUCENTRE COLOR F450” (trade name, manufactured by Fuji Xerox Co., Ltd.) is replaced by the thus-obtained electrophotographic photoreceptor so as to provide a modified machine of “DOCUCENTRE COLOR F450” (described above).

By using the thus-obtained electrophotographic photoreceptor and electrophotographic apparatus, the following measurement and evaluation are performed. The obtained results are shown in the following Table I.

Evaluation of Image Quality

Streaky image density unevenness that is caused due to toner adhesion and depends on the cleaning ability, and fogging in the background that is caused due to wearing of the photosensitive layer are evaluated as follows.

Evaluation of Streaky Image Density Unevenness in Solid Portion

A full color image with an area coverage of 5% is formed on 50,000 sheets of A3 paper (“C2 PAPER” (trade name), manufactured by Fuji Xerox Co., Ltd.) using the remodeled machine in an atmospheric condition of 10° C. temperature and 15% humidity.

At first, a visual inspection to see whether streaky image density unevenness in a solid portion is developed or not is performed on an image formed on the first sheet.

Next, in the course of forming images on 50,000 sheets, the visual inspection to see whether streaky image density unevenness in the solid portion is developed or not is performed so as to evaluate repetition property in accordance with the following evaluation criteria.

Evaluation Criteria

A: Excellent.

B: Practically non-problematic image quality, although streaky image density unevenness is partly slightly developed.

C: Problematic image quality. Streaky image density unevenness is developed.

Evaluation of Fogging in Background

Along with the evaluation of streaky image density unevenness in the solid portion, fogging in the background is evaluated.

At first, a visual inspection to see whether fogging in the background is developed or not is performed on an image formed on the first sheet.

Next, in the course of forming images on 50,000 sheets, the visual inspection to see whether fogging in the background is developed or not is performed. Evaluation is made in accordance with the following evaluation criteria.

Evaluation Criteria

A: No fogging in the background is developed even on the 50,000th sheet.

B: Practically acceptable, although fogging in the background is developed on the sheet 20,000th or more and less than 50,000th.

C: Practically intolerable. Fogging in the background is developed on the sheet less than 20,000th.

### Example 2

8 parts by mass of “LUBRON L-2” (trade name, manufactured by DAIKIN INDUSTRIES, Ltd., tetrafluoroethylene resin particles) and 0.40 parts by mass of a fluoro-alkyl group-containing copolymer that contains the repeating units represented by Structural Formula (4) (50,000 of weight average molecular weight, 1:m=1:1, s=1, n=60) are sufficiently mixed with 27 parts by mass of cyclopentanone (cyclic aliphatic ketone compound) and agitated to prepare a suspension liquid of tetrafluoroethylene resin particles.

Then, 5 parts by mass of a melamine resin and 95 parts by mass of the compound I-16 shown above as a charge-transporting material are added to 210 parts by mass of cyclopentanone; after these are sufficiently dissolved and mixed, the suspension liquid of tetrafluoroethylene resin particles is added thereto. After agitation and mixing, the resulting mixture is subjected to a dispersing treatment with a high pressure homogenizer (trade name: YSNM-1500AR, manufactured by Yoshida Kikai Co., Ltd.) equipped with a feed-through chamber having fine flow channels at an elevated pressure of 700 kgf/cm² repeatedly 20 times. After that, 0.2 parts by mass of “NACURE 5225” (trade name, manufactured by King Industries, Inc.) that serves as a catalyst is added to the mixture so as to prepare a coating liquid for forming a protective layer. Then, an electrophotographic photoreceptor of Example 2 is produced in the substantially similar manner to that of Example 1, except that the coating liquid for forming a protective layer is replaced with that herein formed. Further, preparation of an electrophotographic apparatus and evaluation tests are performed in the substantially similar manner to those of Example 1, except that the electrophotographic photoreceptor of Example 2 is used in place of that of Example 1.

### Example 3

40 parts by mass of “LUBRON L-2” (trade name, manufactured by DAIKIN INDUSTRIES, Ltd., tetrafluoroethylene resin particles) and 2.0 parts by mass of a fluoro-alkyl group-containing copolymer that contains the repeating units represented by Structural Formula (4) (50,000 of weight average molecular weight, 1:m=1:1, s=1, n=60) are sufficiently mixed with 133 parts by mass of cyclopentanone (cyclic aliphatic ketone compound) and agitated to prepare a suspension liquid of tetrafluoroethylene resin particles.

Then, 5 parts by mass of a melamine resin and 95 parts by mass of the compound I-16 shown above as a charge-transporting material are added to 120 parts by mass of cyclopentanone; after these are sufficiently dissolved and mixed, the suspension liquid of tetrafluoroethylene resin particles is added thereto. After agitation and mixing, the resulting mixture is subjected to a dispersing treatment with a high pressure homogenizer (trade name: YSNM-1500AR, manufactured by Yoshida Kikai Co., Ltd.) equipped with a feed-through chamber having fine flow channels at an elevated pressure of 700 kgf/cm² repeatedly 20 times. After that, 0.2 parts by mass of “NACURE 5225” (trade name, manufactured by King Industries, Inc.) that serves as a catalyst is added to the mixture so as to prepare a coating liquid for forming a protective layer. Then, an electrophotographic photoreceptor of Example 3 is produced in the substantially similar manner to that of Example 1, except that the coating liquid for forming a protective layer is replaced with that herein formed. Further, preparation of an electrophotographic apparatus and evaluation tests are performed in the substantially similar manner to those of Example 1, except that the electrophotographic photoreceptor of Example 3 is used in place of that of Example 1.

### Example 4

8 parts by mass of “LUBRON L-2” (trade name, manufactured by DAIKIN INDUSTRIES, Ltd., tetrafluoroethylene resin particles) and 0.40 parts by mass of a fluoro-alkyl group-containing copolymer that contains the repeating units represented by Structural Formula (4) (50,000 of weight average molecular weight, 1:m=1:1, s=1, n=60) are sufficiently mixed with 27 parts by mass of cyclohexanone (cyclic aliphatic ketone compound) and agitated to prepare a suspension liquid of tetrafluoroethylene resin particles.

Then, 5 parts by mass of a melamine resin and 95 parts by mass of the compound I-16 shown above as a charge-transporting material are added to 210 parts by mass of cyclohexanone; after these are sufficiently dissolved and mixed, the suspension liquid of tetrafluoroethylene resin particles is added thereto. After agitation and mixing, the resulting mixture is subjected to a dispersing treatment with a high pressure homogenizer (trade name: YSNM-1500AR, manufactured by Yoshida Kikai Co., Ltd.) equipped with a feed-through chamber having fine flow channels at an elevated pressure of 700 kgf/cm² repeatedly 20 times. After that, 0.2 parts by mass of “NACURE 5225” (trade name, manufactured by King Industries, Inc.) that serves as a catalyst is added to the mixture so as to prepare a coating liquid for forming a protective layer. Then, an electrophotographic photoreceptor of Example 4 is produced in the substantially similar manner to that of Example 1, except that the coating liquid for forming a protective layer is replaced with that herein formed. Further, preparation of an electrophotographic apparatus and evaluation tests are performed in the substantially similar manner to those of Example 1, except that the electrophotographic photoreceptor of Example 4 is used in place of that of Example 1.

### Example 5

8 parts by mass of “LUBRON L-2” (trade name, manufactured by DAIKIN INDUSTRIES, Ltd., tetrafluoroethylene resin particles) and 0.40 parts by mass of a fluoro-alkyl group-containing copolymer that contains the repeating units represented by Structural Formula (4) (50,000 of weight average molecular weight, 1:m=1:1, s=1, n=60) are sufficiently mixed with 27 parts by mass of cyclopentanone (cyclic aliphatic ketone compound) and agitated to prepare a suspension liquid of tetrafluoroethylene resin particles.

Then, 5 parts by mass of a guanamine resin and 95 parts by mass of the compound I-16 shown above as a charge-transporting material are added to 210 parts by mass of cyclopentanone; after these are sufficiently dissolved and mixed, the suspension liquid of tetrafluoroethylene resin particles is added thereto. After agitation and mixing, the resulting mixture is subjected to a dispersing treatment with a high pressure homogenizer (trade name: YSNM-1500AR, manufactured by Yoshida Kikai Co., Ltd.) equipped with a feed-through chamber having fine flow channels at an elevated pressure of 700 kgf/cm² repeatedly 20 times. After that, 0.2 parts by mass of “NACURE 5225” (trade name, manufactured by King Industries, Inc.) that serves as a catalyst is added to the mixture so as to prepare a coating liquid for forming a protective layer. Then, an electrophotographic photoreceptor of Example 5 is produced in the substantially similar manner to that of Example 1, except that the coating liquid for forming a protective layer is replaced with that herein formed. Further, preparation of an electrophotographic apparatus and evaluation tests are performed in the substantially similar manner to those of Example 1, except that the electrophotographic photoreceptor of Example 5 is used in place of that of Example 1.

### Example 6

8 parts by mass of “LUBRON L-2” (trade name, manufactured by DAIKIN INDUSTRIES, Ltd., tetrafluoroethylene resin particles) and 0.40 parts by mass of a fluoro-alkyl group-containing copolymer that contains the repeating units represented by Structural Formula (4) (50,000 of weight average molecular weight, 1:m=1:1, s=1, n=60) are sufficiently mixed with 27 parts by mass of cyclopentanone (cyclic aliphatic ketone compound) and agitated to prepare a suspension liquid of tetrafluoroethylene resin particles.

Then, 5 parts by mass of a melamine resin and 79 parts by mass of the compound I-16 shown above as a charge-transporting material are added to 210 parts by mass of cyclopentanone; after these are sufficiently dissolved and mixed, the suspension liquid of tetrafluoroethylene resin particles is added thereto. After agitation and mixing, the resulting mixture is subjected to a dispersing treatment with a high pressure homogenizer (trade name: YSNM-1500AR, manufactured by Yoshida Kikai Co., Ltd.) equipped with a feed-through chamber having fine flow channels at an elevated pressure of 700 kgf/cm² repeatedly 20 times. After that, 0.2 parts by mass of “NACURE 5225” (trade name, manufactured by King Industries, Inc.) that serves as a catalyst is added to the mixture so as to prepare a coating liquid for forming a protective layer. Then, an electrophotographic photoreceptor of Example 6 is produced in the substantially similar manner to that of Example 1, except that the coating liquid for forming a protective layer is replaced with that herein formed. Further, preparation of an electrophotographic apparatus and evaluation tests are performed in the substantially similar manner to those of Example 1, except that the electrophotographic photoreceptor of Example 6 is used in place of that of Example 1.

### Comparative Example 1

5 parts by mass of a melamine resin and 95 parts by mass of the compound I-16 shown above as a charge-transporting material are added to 240 parts by mass of cyclopentanone. After these are sufficiently dissolved and mixed, 0.2 parts by mass of “NACURE 5225” (trade name, manufactured by King Industries, Inc.) that serves as a catalyst is added to the mixture so as to prepare a coating liquid for forming a protective layer. Then, an electrophotographic photoreceptor of Comparative example 1 is produced in the substantially similar manner to that of Example 1, except that the coating liquid for forming a protective layer is replaced with that herein formed. Further, preparation of an electrophotographic apparatus and evaluation tests are performed in the substantially similar manner to those of Example 1, except that the electrophotographic photoreceptor of Comparative example 1 is used in place of that of Example 1.

### Comparative example 2

8 parts by mass of “LUBRON L-2” (trade name, manufactured by DAIKIN INDUSTRIES, Ltd., tetrafluoroethylene resin particles) and 0.40 parts by mass of a fluoro-alkyl group-containing copolymer that contains the repeating units represented by Structural Formula (4) (50,000 of weight average molecular weight, 1:m=1:1, s=1, n=60) are sufficiently mixed with 27 parts by mass of toluene and agitated to prepare a suspension liquid of tetrafluoroethylene resin particles.

Then, 5 parts by mass of a melamine resin and 95 parts by mass of the compound I-16 shown above as a charge-transporting material are added to 140 parts by mass of tetrahydrofuran and 33 parts by mass of toluene; after these are sufficiently dissolved and mixed, the suspension liquid of tetrafluoroethylene resin particles is added thereto. After agitation and mixing, the resulting mixture is subjected to a dispersing treatment with a high pressure homogenizer (trade name: YSNM-1500AR, manufactured by Yoshida Kikai Co., Ltd.) equipped with a feed-through chamber having fine flow channels at an elevated pressure of 700 kgf/cm² repeatedly 20 times. After that, 0.2 parts by mass of “NACURE 5225” (trade name, manufactured by King Industries, Inc.) that serves as a catalyst is added to the mixture so as to prepare a coating liquid for forming a protective layer. Then, an electrophotographic photoreceptor of Comparative example 2 is produced in the substantially similar manner to that of Example 1, except that the coating liquid for forming a protective layer is replaced with that herein formed. Further, preparation of an electrophotographic apparatus and evaluation tests are performed in the substantially similar manner to those of Example 1, except that the electrophotographic photoreceptor of Comparative example 2 is used in place of that of Example 1.

TABLE 1

| | | | | | | Image quality | | Image quality | |
|---|---|---|---|---|---|---|---|---|---|
| | Ratio | | | | | (first sheet) | | (repetition property) | |
| | of | | Ratio of | | | Streaky | | Streaky | |
| | fluorine | Ratio of | charge- | PTFE | | image | | image | |
| | atom | thermosetting | transporting | con- | | density | | density | |
| | present | material | material | centration | | unevenness | | unevenness | |
| | (% by | (% by mass) | (% by mass) | (% by | | in solid | Fogging in | in solid | Fogging in |
| | mass) | (*1) | (*1) | mass) | Solvent | portion | background | portion | background |
| Example 1 | 2.0 | Melamine | 95 | 4.8 | Cyclo- | Not | Not | A | A |
| | | 5.0 | | | pentanone | developed | developed | | |
| Example 2 | 3.0 | Melamine | 95 | 7.4 | Cyclo- | Not | Not | A | A |
| | | 5.0 | | | pentanone | developed | developed | | |
| Example 3 | 11.8 | Melamine | 95 | 28.2 | Cyclo- | Not | Not | A | A |
| | | 5.0 | | | pentanone | developed | developed | | |
| Example 4 | 3.0 | Melamine | 95 | 7.4 | Cyclo- | Not | Not | A | A |
| | | 5.0 | | | Hexanone | developed | developed | | |
| Example 5 | 2.9 | Guanamine | 95 | 7.4 | Cyclo- | Not | Not | A | A |
| | | 5.0 | | | pentanone | developed | developed | | |
| Example 6 | 3.1 | Melamine | 79 | 7.4 | Cyclo- | Not | Not | A | A |
| | | 5.0 | | | pentanone | developed | developed | | |
| | | | | | | (Ghost is developed)(*2) | | | |
| Comparative | 0 | Melamine | 95 | 0 | Cyclo- | Developed a | Not | C | C |
| example 1 | | 5.0 | | | pentanone | little | developed | | |
| Comparative | 0.1 | Melamine | 95 | 7.4 | THF/toluene | Developed a | Not | A | A |
| example 2 | | 5.0 | | | | little | developed | | |

In Table 1, “ratio of thermosetting material” and “ratio of charge-transporting material” that are designated by the mark (*1) are the ratios of contents with respect to the total solid content of the overcoat layer excluding the content of the fluoro-resin particles (tetrafluoroethylene resin particles) and the content of the fluoro-alkyl group-containing copolymer. Further, in the evaluation of “ghost is developed” that is designated by the mark (*2), the ghost indicates an occurrence of remaining of an exposure hysteresis (exposed image) of the preceding printing cycle in the succeeding printing cycle upon forming images. The ghost is evaluated in accordance with a sensory rating in which the printed image is compared with a reference image.

The foregoing description of the exemplary embodiments of the invention has been provided for the purposes of illustration and description. It is not intended to be exhaustive or to limit the invention to the precise forms disclosed. Obviously, many modifications and variations will be apparent to practitioners skilled in the art. The exemplary embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An electrophotographic photoreceptor comprising:
a substrate;
a photosensitive layer provided on the substrate; and
an overcoat layer provided on the photosensitive layer, the overcoat layer of the photoreceptor comprising:
a cross-linked component that is obtained by cross-linking of at least one selected from a guanamine compound or a melamine compound and a charge-transporting material having at least one substituent group selected from —OH, —OCH₃, —NH₂, —SH, or —COOH;
fluoro-resin particles; and
a fluoro-alkyl group-containing copolymer, and the ratio of fluorine atom present in an outermost surface of the overcoat layer as measured with energy dispersive X-ray analysis (EDS) being from approximately 1.0% by mass to approximately 20.0% by mass.

2. The electrophotographic photoreceptor of claim 1, wherein, in the overcoat layer:
the ratio of the sum of the content of the guanamine compound and the content of the melamine compound to the total solid content of the overcoat layer excluding the content of the fluoro-resin particles and the content of the fluoro-alkyl group-containing copolymer is from approximately 0.1% by mass to approximately 20% by mass; and
the ratio of the content of the charge-transporting material to the total solid content of the overcoat layer excluding the content of the fluoro-resin particles and the content of the fluoro-alkyl group-containing copolymer is from approximately 80% by mass to approximately 99.9% by mass.

3. The electrophotographic photoreceptor of claim 2, wherein, in the overcoat layer,
the ratio of the sum of the content of the guanamine compound and the content of the melamine compound to the total solid content of the overcoat layer excluding the content of the fluoro-resin particles and the content of the fluoro-alkyl group-containing copolymer is from approximately 0.1% by mass to approximately 10% by mass.

4. The electrophotographic photoreceptor of claim 2, wherein, in the overcoat layer:
the ratio of the content of the charge-transporting material to the total solid content of the overcoat layer excluding the content of the fluoro-resin particles and the content of the fluoro-alkyl group-containing copolymer is from approximately 95% by mass to approximately 99.5% by mass.

5. The electrophotographic photoreceptor of claim 1, wherein the fluoro-alkyl group-containing copolymer is a copolymer comprising a repeating unit represented by the following Structural Formula (1) and a repeating unit represented by the following Structural Formula (2): 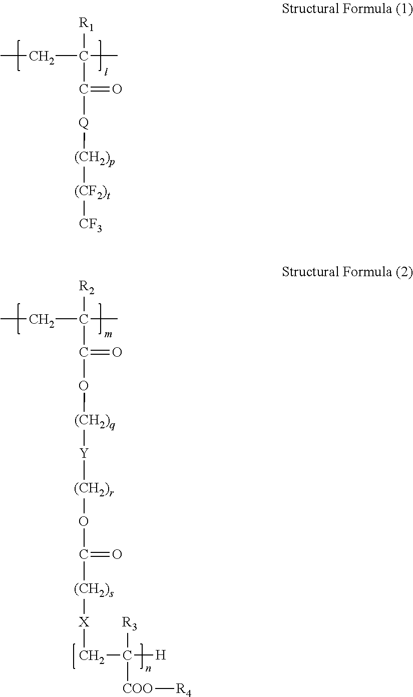
wherein l, m and n each independently represent an integer equal to or larger than 1; p, q, r and each independently represent 0 or an integer equal to or larger than 1; t represents an integer of 1 to 7; R₁, R₂, R₃ and R₄ each independently represent a hydrogen atom or an alkyl group; X represents an alkylene chain, a halogen-substituted alkylene chain, —S—, —O—, —NH— or a single bond; Y represents an alkylene chain, a halogen-substituted alkylene chain, —(C_{z}H_{2z-1}(OH))— or a single bond; z represents an integer equal to or larger than 1; and Q represents —O— or —NH—.

6. The electrophotographic photoreceptor of claim 1, wherein the guanamine compound is a compound represented by the following Formula (A) or an oligomer of the compound represented by Formula (A): 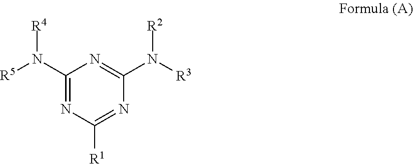
wherein R¹ represents a linear or branched alkyl group having 1 to 10 carbon atoms, a substituted or unsubstituted phenyl group having 6 to 10 carbon atoms, or a substituted or unsubstituted alicyclic hydrocarbon group having 4 to 10 carbon atoms; and R² through R⁵ each independently represent a hydrogen atom, —CH₂—OH or —CH₂—O—R⁶ wherein R⁶ represents a hydrogen atom or a linear or branched alkyl group having 1 to 10 carbon atoms.

7. The electrophotographic photoreceptor of claim 1, wherein the melamine compound is a compound represented by the following Formula (B) or an oligomer of the compound represented by Formula (B): 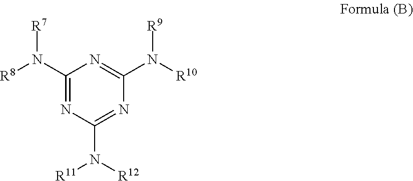
wherein R⁷ through R¹² each independently represent a hydrogen atom, —CH₂—OH or —CH₂—O—R¹³, wherein R¹³ represents a linear or branched alkyl group having 1 to 5 carbon atoms.

8. The electrophotographic photoreceptor of claim 1, wherein the charge transporting material is a compound represented by the following Formula (I):
F_{H}—((—R¹⁴—X)ₙ₁(R¹⁵)ₙ₃—Y)ₙ₂ Formula (I)
wherein F₁ represents an organic group derived from a compound having a hole transporting ability; R¹⁴ and R¹⁵ each independently represent a linear or branched alkylene group having 1 to 5 carbon atoms; n1 represents 0 or 1; n2 represents an integer of 1 to 4; n3 represents 0 or 1; X represents an oxygen atom, NH, or a sulfur atom; and Y represents —OH, —OCH₃, —NH₂, —SH, or —COOH.

9. A process cartridge comprising:
the electrophotographic photoreceptor of claim 1; and
at least one selected from a charging unit, a development unit, or a cleaning unit, and
being freely attachable to and detachable from an image forming apparatus.

10. The process cartridge of claim 9, wherein, in the overcoat layer of the electrophotographic photoreceptor:
the ratio of the sum of the content of the guanamine compound and the content of the melamine compound to the total solid content of the overcoat layer excluding the content of the fluoro-resin particles and the content of the fluoro-alkyl group-containing copolymer is from approximately 0.1% by mass to approximately 20% by mass; and
the ratio of the content of the charge-transporting material to the total solid content of the overcoat layer excluding the content of the fluoro-resin particles and the content of the fluoro-alkyl group-containing copolymer is from approximately 80% by mass to approximately 99.9% by mass.

11. The process cartridge of claim 10, wherein, in the overcoat layer of the electrophotographic photoreceptor,
the ratio of the sum of the content of the guanamine compound and the content of the melamine compound to the total solid content of the overcoat layer excluding the content of the fluoro-resin particles and the content of the fluoro-alkyl group-containing copolymer is from approximately 0.1% by mass to approximately 10% by mass.

12. The process cartridge of claim 9, wherein in the electrophotographic photoreceptor, the fluoro-alkyl group-containing copolymer is a copolymer comprising a repeating unit represented by the following Structural Formula (1) and a repeating unit represented by the following Structural Formula (2): 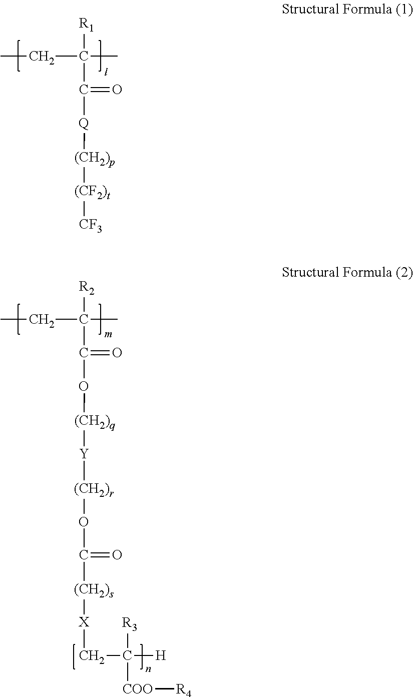
wherein l, m and n each independently represent an integer equal to or larger than 1; p, q, r and each independently represent 0 or an integer equal to or larger than 1; t represents an integer of 1 to 7; R₁, R₂, R₃ and R₄ each independently represent a hydrogen atom or an alkyl group; X represents an alkylene chain, a halogen-substituted alkylene chain, —S—, —O—, —NH— or a single bond; Y represents an alkylene chain, a halogen-substituted alkylene chain, —(C_{z}H_{2z-1}(OH))— or a single bond; z represents an integer equal to or larger than 1; and Q represents —O— or —NH—.

13. An image forming apparatus comprising:
the electrophotographic photoreceptor of claim 1;
a charging unit that charges the electrophotographic photoreceptor;
a latent image forming unit that forms an electrostatic latent image on a surface of the electrophotographic photoreceptor;
a development unit that develops the electrostatic latent image formed on the surface of the electrophotographic photoreceptor with a toner and forms a toner image; and
a transferring unit that transfers the toner image formed on the surface of the electrophotographic photoreceptor onto a recording medium.

14. The image forming apparatus of claim 13, wherein, in the overcoat layer of the electrophotographic photoreceptor:
the ratio of the sum of the content of the guanamine compound and the content of the melamine compound to the total solid content of the overcoat layer excluding the content of the fluoro-resin particles and the content of the fluoro-alkyl group-containing copolymer is from approximately 0.1% by mass to approximately 20% by mass; and
the ratio of the content of the charge-transporting material to the total solid content of the overcoat layer excluding the content of the fluoro-resin particles and the content of the fluoro-alkyl group-containing copolymer is from approximately 80% by mass to approximately 99.9% by mass.

15. The image forming apparatus of claim 14, wherein, in the overcoat layer of the electrophotographic photoreceptor,
the ratio of the sum of the content of the guanamine compound and the content of the melamine compound to the total solid content of the overcoat layer excluding the content of the fluoro-resin particles and the content of the fluoro-alkyl group-containing copolymer is from approximately 0.1% by mass to approximately 10% by mass.

16. The image forming apparatus of claim 13, wherein in the electrophotographic photoreceptor, the fluoro-alkyl group-containing copolymer is a copolymer comprising a repeating unit represented by the following Structural Formula (1) and a repeating unit represented by the following Structural Formula (2): 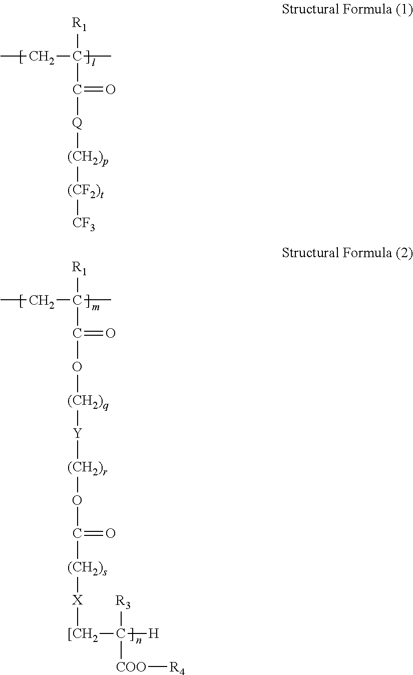
wherein l, m and n each independently represent an integer equal to or larger than 1; p, q, r and each independently represent 0 or an integer equal to or larger than 1; t represents an integer of 1 to 7; R₁, R₂, R₃ and R₄ each independently represent a hydrogen atom or an alkyl group; X represents an alkylene chain, a halogen-substituted alkylene chain, —S—, —O—, —NH— or a single bond; Y represents an alkylene chain, a halogen-substituted alkylene chain, —(C_{z}H_{2z-1}(OH))— or a single bond; z represents an integer equal to or larger than 1; and Q represents —O— or —NH—.

17. A method of producing an electrophotographic photoreceptor comprising:
preparing a substrate having one or more layers, the one or more layers being other than an overcoat layer comprising an outermost surface layer; and
forming the overcoat layer by applying a coating liquid on the substrate and cross-linking components of the coating liquid applied on the substrate,
the coating liquid comprising:
at least one selected from a guanamine compound or a melamine compound and a charge-transporting material having at least one substituent group selected from —OH, —OCH₃, —NH₂, —SH, or —COOH;
fluoro-resin particles;
a fluoro-alkyl group-containing copolymer; and
a cyclic aliphatic ketone compound, and
the coating liquid having a ratio of the sum of the content of the guanamine compound and the content of the melamine compound to the total solid content of the overcoat layer excluding the content of the fluoro-resin particles and the content of the fluoro-alkyl group-containing copolymer of from approximately 0.1% by mass to approximately 20% by mass, and the ratio of the content of the charge-transporting material to the total solid content of the coating liquid excluding the content of the fluoro-resin particles and the content of the fluoro-alkyl group-containing copolymer of from approximately 80% by mass to approximately 99.9% by mass.

18. The method of claim 17, wherein the number of carbon atoms that compose the ring of the cyclic aliphatic ketone compound is from 4 to 7.
